(19) United States
(12) Patent Application Publication
(10) Pub. No.: US 2026/0349180 A1
(43) Pub. Date: Nov. 5, 2026

(54) LOW-INDEX-CONTRAST RING RESONATOR

(71) Applicant: Nvidia Corporation, Santa Clara, CA (US)

(72) Inventors: Peng SUN, San Diego, CA (US); Liron GANTZ, Haifa (IL)

(21) Appl. No.: 19/340,994

(22) Filed: Sep. 26, 2025

Related U.S. Application Data
(60) Provisional application No. 63/789,707, filed on Apr. 16, 2025.

(51) Int. Cl. G02B 6/293

(52) U.S. Cl. CPC G02B 6/29343

(57) ABSTRACT

A segmented ring resonator is provided. The segmented ring resonator includes a first waveguide formed as a first arc; a second waveguide formed as a second arc; and a pair of reflectors. The pair of reflectors are configured to optically couple respective ends of the first waveguide and the second waveguide to form a closed optical path. A segmented ring resonator may be incorporated into an optical element such as an optical filter or a modulator.

### CROSS-REFERENCE TO RELATED APPLICATION(S)

This application claims priority to U.S. Application No. 63/789,707, filed Apr. 16, 2025, the content of which is incorporated herein by reference in its entirety.

### BACKGROUND

Ring resonators are used in a variety of optical elements such as optical modulators and optical filters. These optical elements may be incorporated into transmitter modules and/or receiver modules of optical transceivers. For example, optical elements may be incorporated into optical transceivers configured to receive and/or provide optical signals that include multiple streams of data encoded therein via wavelength division multiplexing (WDM). In WDM, multiple data streams are encoded onto respective spectral lines of an optical signal comprising a plurality of spectral lines. A transmitter module includes a modulator for each optical channel and each receiver module includes a filter for each optical channel. As a result, the electrical power required to thermally tune ring resonators of the modulators and/or filters is significant. Additionally, the modulators and/or filters may require a significant surface area of the chip(s) on which they are formed and/or disposed. Accordingly, a need exists for ring resonators that are power efficient and size efficient.

### GENERAL DESCRIPTION

Datacenters rely on a fast and robust communication infrastructure. This is achieved by using optical interconnects, especially between different server racks. Each physical link employing a single optical fiber may include multiple communication channels, which are distinguished by different wavelengths in wavelength division multiplexing (WDM) systems. Such optical interconnects tend to include transceivers that are in optical communication with one another via one or more optical fibers. A transceiver includes one or more transmitter modules and/or one or more receiver modules. Transmitter modules include optical modulators configured to encode streams of data onto spectral lines of an optical signal and receiver modules include optical filters configured to isolate respective spectral lines of an optical signal to extract the stream of data encoded thereon. Optical modulators and optical filters are examples of optical elements that may include segmented ring resonators, of various embodiments.

Conventionally, ring resonators are formed as a continuous ring or annular waveguide comprising silicon. Silicon has optical effects that are sensitive to temperature. For example, the resonant wavelength of the silicon ring resonator is conventionally thermally tuned (e.g., via application of heat to the ring resonator). This heat is generally electrically generated. For WDM schemes that include a plurality of wavelengths, the electrical power used to thermally tune the ring resonators may be significant.

Various embodiments provide segmented ring resonators. In some embodiments, a segmented ring resonator is fabricated using low index contrast materials that are much less sensitive to temperature fluctuation such as SiN, LiNbO₃, or BaTiO₃ to take advantage of the lower thermal refractive coefficient of SiN, LiNbO₃, or BaTiO₃ (compared to Si). However, SiN, LiNbO₃, and BaTiO₃ each have a lower refractive index than Si. As a result, SiN, LiNbO₃, or BaTiO₃ ring resonators require a larger bending radius than Si ring resonators. The additional chip space required to accommodate the larger bending radius of the SiN, LiNbO₃, or BaTiO₃ ring resonator is prohibitive. Moreover, ring resonators having larger radii also have a smaller free-spectral range (FSR) (compared to ring resonators having smaller radii), which limits the number of WDM channels available. Additionally, the larger the radius of a ring, the greater the thermal mass of the ring. The higher the thermal mass of a ring, the more energy (e.g., electrical power) is consumed to tune the ring to align the ring resonances with the laser wavelength.

Various embodiments address this problem by providing a segmented ring resonator that includes a least two arc waveguides characterized by a large bending radius that are optically coupled to one another via reflectors (e.g., Bragg mirrors). In certain embodiments, the reflectors are configured to satisfy phase-matching conditions in order to maximize reflectivity. In some embodiments, the segmented ring resonator has an effective ring radius that is three times smaller than would be required by a conventional SiN, LiNbO₃, or BaTiO₃ ring resonator, providing a compact low index contrast ring resonator. The combination of large-radius arcs (which are configured to have low bending loss) and highly reflective mirrors (which are configured to have low scattering loss) ensures efficient operation.

According to one aspect of the present disclosure, a segmented ring resonator is provided. In an example embodiment, the segmented ring resonator includes a first waveguide formed as a first arc; a second waveguide formed as a second arc; and a pair of reflectors, wherein the pair of reflectors are configured to optically couple respective ends of the first waveguide and the second waveguide.

In an example embodiment, at least one reflector of the pair of reflectors is a Bragg reflector. In certain embodiments, the Bragg reflector is configured to satisfy one or more phase matching conditions. In some embodiments, the Bragg reflector is configured as confocal ellipses. In an example embodiment, both reflectors of the pair of reflectors are Bragg reflectors. In an example embodiment, a reflectivity of the Bragg reflector increases adiabatically with a distance into the Bragg reflector from a front surface of the Bragg reflector.

In an example embodiment, the first waveguide and the second waveguide comprise a waveguide material. In an example embodiment, the waveguide material is SiN, LiNbO₃, BaTiO₃. In an example embodiment, an optical path of the segmented ring resonator has an optical length that is less than half the circumference of a circle characterized by the radius of curvature. In an example embodiment, a refractive index of the waveguide material is substantially stable over an operation range of temperatures.

In an example embodiment, the first arc and the second arc are characterized by a radius of curvature.

According to another aspect of the present disclosure a resonator is provided. The resonator includes a first waveguide extending from a first waveguide end to a second waveguide end; a second waveguide extending from a third waveguide end to a fourth waveguide end; a first reflector configured to optically couple the second waveguide end to the third waveguide end; and a second reflector configured to optically couple the fourth waveguide end to the first waveguide end.

In an example embodiment, the first reflector and the second reflector are Bragg reflectors.

In an example embodiment, the first waveguide and the second waveguide are characterized by a non-zero radius of curvature. In an example embodiment, an optical path of the resonator has an optical length that is less than half the circumference of a circle characterized by the radius of curvature. In an example embodiment, first waveguide and the second waveguide comprise a waveguide material and the waveguide material is SiN, LiNbO₃, or BaTiO₃.

According to another aspect of the present disclosure a segmented ring resonator is provided. The segmented ring resonator comprises a plurality of ring waveguide segments and a plurality of reflectors, wherein each reflector of the plurality of reflectors is configured to optically couple a pair of ring waveguide segments of the plurality of ring waveguide segments to define a closed optical path through the plurality of ring waveguide segments.

According to another aspect of the present disclosure, an optical element is provided. In an example embodiment, the optical element includes a segmented ring resonator that includes a first waveguide and a second waveguide that are optically coupled to one another via a pair of reflectors. The optical element further includes a through waveguide that is evanescently coupled to the segmented ring resonator (e.g., the first waveguide). The optical element may be a modulator, filter, or other optical element that uses the optical resonance of the segmented ring resonator to perform an optical function.

According to another aspect, an optical link transceiver is provided. In various embodiments, the optical link transceiver includes one or more optical elements of an example embodiment.

In an example embodiment, the optical link transceiver includes a transmitter module that comprises one or more optical elements that are respective modulators configured to encode respective channels of data onto respective spectral lines of an optical signal comprising a plurality of spectral lines.

In an example embodiment, the optical link transceiver includes a receiver module that comprises one or more optical elements that are respective optical filters configured to filter an optical channel characterized by a respective wavelength from a multi-wavelength optical signal.

In various embodiments, an optical link transceiver is in optical communication with another optical link transceiver via one or more optical fibers, waveguides, and/or the like. For example, various embodiments provide optical interconnects that include optical link transceivers comprising segmented ring resonators of various embodiments.

In at least one example embodiment, the optical interconnect is part of a datacenter that corresponds to a collection of network devices, such as network switches (e.g., Ethernet switches, IP routers, multiservice platforms, various transmission network elements, legacy communication equipment, or in any other suitable communication system) connected with a collection of servers or compute nodes. A switch fabric serves to transfer the data between the switch ports. A switch fabric comprises one or more interconnect circuits, which may be arranged in various switch fabric architectures, e.g., m*m crossbar, Banyan, Benes, Omega, Clos, multi-plane, STS, TST, shared memory, buffered crossbar, any other suitable blocking or non-blocking architecture, or any applicable mixed architecture thereof. A switch fabric is realized in typical embodiments by hardware, which may comprise Field-Programmable Gate Arrays (FPGAs) and/or Application-Specific Integrated Circuits (ASICs), and in some implementations also bus interconnects. The datacenter may adhere to a networking topology (e.g., a hierarchal networking topology), such as a fat tree topology, a Slim Fly topology, a Dragonfly topology, and/or the like. The datacenter routes traffic amongst the network switches and servers therein, and at least one layer of the topology in the datacenter is coupled to the communication network to allow networking traffic to flow between the datacenter and the network device(s).

The optical interconnect may include a substrate, an electro-optical component (frequency comb laser source, photodiode, etc.) supported by the substrate and configured to convert electrical signals to optical signals or vice versa, and one or more segmented ring resonators configured for isolating respective optical channels communicated via the optical interconnect. The optical interconnect may further include a transmission block defining a receiving surface configured to receive an optical fiber, and a waveguide configured to transmit optical signals between the electro-optical component and the receiving surface such that in an operational configuration in which the receiving surface receives an optical fiber, the electro-optical component and the optical fiber are in optical communication.

While the present disclosure illustrates and describes the optical interconnect without a housing or other protective casing, as would be understood by one of ordinary skill in the art in light of the present disclosure, some or all of the optical interconnect may be supported or enclosed by any housing used in communications systems to protect the components supported therein (e.g., as part of Quad Small Form-factor Pluggable (QSFP) connectors, Small Form Pluggable (SFP) connectors, or the like). Furthermore, the substrate hosting the electro-optical component may be substantially rectangular shape and/or may be dimensioned (e.g., sized and shaped) for use in any communication system regardless of geometric constraints (e.g., L-shaped, squared-shaped, etc.).

In various embodiments, an optical interconnect for receiving an optical fiber may be implemented in a flip-chip configuration. In certain embodiments, the optical interconnect is configured as a flip-chip component such that a longitudinal axis of the first adiabatic transition profile of the optical interconnect and a longitudinal axis of the second adiabatic transition profile of the optical interconnect may be collinear. Said differently, the orientation of the optical interconnect in such an embodiment does not require a mirror or other reflective surface to redirect optical signals between the electro-optical component and the receiving surface. As would be evident to one of ordinary skill in the art in light of the present disclosure, however, the optical interconnect in a flip-chip configuration may also include one or more mirrors (e.g., reflective surfaces) to accommodate optical fibers received at varying angles. In some optical interconnect embodiments, only mirrors may be operationally configured to redirect light given that at some bending radii, light may remain confined to the waveguide. Accordingly, embodiments of a field replaceable modular optical interconnect unit are described that are configured to be received by a main switch system box. The field replaceable modular optical interconnect unit comprises a housing comprising at least a front panel, a rear panel, and side panels extending between the front and rear panels, a printed circuit board assembly supported within the housing, an optical module supported on the printed circuit board assembly and configured to convert between optical signals and corresponding electrical signals for respectively transmitting or receiving optical signals through a fiber optic cable, a board-to-board connector disposed on the rear panel of the housing and configured to enable electrical signals to be transmitted between the printed circuit board assembly and a main switch system box, and an external connector disposed on the front panel of the housing and configured to engage an external optical fiber for transmitting optical signals between the optical module and an external component. The field replaceable modular optical interconnect unit may be configured to be electrically connected to the main switch system box via engagement of the board-to-board connector with a corresponding connector of the main switch system box when the housing is received by the main switch system box.

In some embodiments, the optical module may be a mid-board optical module (MBOM), and/or the field replaceable modular optical interconnect unit may comprise a plurality of external connectors. For example, the external connector may be a first external connector, and the field replaceable modular optical interconnect unit may further comprise a second external connector disposed on the front panel of the housing and configured to enable transmission of electrical signals between the printed circuit board assembly and an external component connected thereto.

In some embodiments, the disclosed technique provides an electro-optical (EO) interconnect assembly comprising a pair of pluggable EO transceivers connected at respective ends of an optical fiber. The EO transceivers are typically used to connect network-connected devices (e.g., remote client switches, network adapters such as Network Interface controllers (NICs) and Host Channel Adapters (HCAs), Smart-NICs (NICs having embedded CPUs), network-enabled Graphics Processing Units (GPUs), and the like). The terms “network-connected device” and “network device” are used interchangeably herein. In certain embodiments, an optical interconnect includes a substrate, one or more optical waveguides, one or more first micro-lenses, one or more second micro-lenses, and first and second mechanical fixtures.

Various embodiments relate to interconnects (e.g., interconnect topologies) that are scalable and advantageous for networks that require a large number of all-to-all or point-to-point links between one or more node or send/receive pairs. In particular, silicon photonics interconnects or topologies are provided herein that may achieve at least moderate bandwidth between many nodes with physical, optical fiber connections. In some implementations, the one or more node or send/receive pairs are coupled with an optical fiber allowing a single wavelength to pass therebetween. In other implementations, multiple wavelengths or groups of wavelengths may be transmitted or received by nodes while simultaneously passing multiple wavelengths or groups of wavelengths to other nodes via optical fiber loops connecting three or more nodes. In some implementations, such interconnects as described herein do not rely on or include one or more of the following: wavelength synchronization between transmit and receive pairs, arbitration of the fiber(s), demultiplexers on the receiver side, and/or an optical crossbar. In some implementations, the optical interconnects may be sized to fit a face-plate form factor or as a mid-board optical connector or co-packaged optics. In some embodiments, the present disclosure provides optical interconnects for high bandwidth density applications like switches and GPUs or other processing elements. In one example, the processing elements may include central processing units (CPUs), graphics processing units (GPUs), data processing units (DPUs), quantum processing units (QPUs), a plurality of parallel processing units (PPUs), and application-specific integrated circuits (ASICs). QPUs are configured to perform one or more operations associated with a quantum algorithm. In some embodiments, each of the one or more QPUs may include a plurality of qubits and the one or more QPUs may be in communication with each other via a quantum channel. In some embodiments, each of the plurality of qubits may include local qubits, global qubits, and/or synchronization qubits. In some embodiments, the local qubits of each QPU may be configured to perform the one or more operations associated with the quantum algorithm on the QPU that the local qubits are associated with.

A “node” as described herein may refer to a network switch to which a plurality of computer processing units (CPUs), graphical processing units (GPUs), data processing units (DPUs), or memory media are connected in an arbitrary number. The network switch may communicate with other network switches of the same kind to which the same processor and memory units may be connected. However, in other implementations, “node” may also refer to a processor which may be responsible for communication with all other nodes in the network or subnetwork.

An “optical fiber” as described herein can refer to a single optical fiber (e.g., including a core and a cladding) to provide unidirectional optical communication, can refer to a bidirectional pair of optical fibers (e.g., each including a core and a cladding) to provide both transmit and receive communications in an optical network, or can refer to a multi-core fiber, such that a single cladding could encapsulate a plurality of single-mode or multi-mode cores. Optical fibers can extend contiguously and uninterrupted between node or send/receive pairs (e.g., via pass-through connections) or include two or more fibers connected via fiber-to-fiber connections such that the fibers function or perform as a single fiber.

Silicon Photonics (SiP) is a technology that enables optical systems to be manufactured using silicon processes with silicon as the optical medium. Various optical components, such as interconnects and signal processing components, may be fabricated and integrated in a single SiP device. Some SiP devices are fabricated on a silica substrate or over a silica layer on a silicon substrate, a technology that is often referred to as Silicon on Insulator (SOI). In certain optical systems, a SiP device is attached to an external device to facilitate optical communications. However, it is generally difficult to accurately align light signals on the SiP with an external device that receives the light.

In certain optical systems, a SiP device is attached to an external device to facilitate optical communications. For example, the system includes one or more waveguides that carry light signals to and/or from optical chips. Examples of optical chips that can be included on the device include, but are not limited to, one or more components selected from a group consisting of facets through which light signals can enter and/or exit a waveguide, entry/exit ports through which light signals can enter and/or exit a waveguide from above or below the device, multiplexers for combining multiple light signals onto a single waveguide, demultiplexers for separating multiple light signals such that different light signals are received on different waveguides, optical couplers, optical switches, lasers that act as a source of a light signal, amplifiers for amplifying the intensity of a light signal, attenuators for attenuating the intensity of a light signal, modulators for modulating a signal onto a light signal, modulators that convert a light signal to an electrical signal, and vias that provide an optical pathway for a light signal traveling through the device. Additionally, the device can optionally, include electrical components. For instance, the device can include electrical connections for applying a potential or current to a waveguide, controlling active optical components, such as modulators, for example, and/or for controlling other components on the optical device.

### BRIEF DESCRIPTION OF THE SEVERAL VIEWS OF THE DRAWINGS

Reference will now be made to the accompanying drawings, which are not necessarily drawn to scale, and wherein:

FIG. 1 provides a schematic top view an example segmented ring resonator, in accordance with certain embodiments;

FIG. 1A provides a schematic top view of a conventional ring resonator;

FIG. 1B provides a schematic top view of another example segmented ring resonator, in accordance with certain embodiments;

FIG. 2 provides a schematic illustration of a reflector optically coupling a first waveguide arc and a second waveguide arc, in accordance with certain embodiments;

FIG. 3 provides a schematic cross-sectional diagram of a reflector, in accordance with certain embodiments;

FIG. 4A provides simulation results of reflector optically coupling a first waveguide arc to a second waveguide arc, in accordance with certain embodiments;

FIG. 4B illustrates the structure of the first waveguide arc, the reflector, and the second waveguide arc used to generate the simulation results illustrated in FIG. 4A;

FIG. 5A illustrates a portion of an example segmented ring resonator, in accordance with certain embodiments, used to generate the simulation results shown in FIG. 5B;

FIG. 5B illustrates a plot showing the transmission of a segmented ring resonator as a function of wavelength, in accordance with an example embodiment;

FIG. 6A provides a top view of an example optical element comprising a segmented ring resonator, in accordance with certain embodiments;

FIG. 6B provides a plot showing the transmission of the segmented ring resonator and a second waveguide evanescently coupled to the segmented ring resonator, in accordance with certain embodiments;

FIG. 7 provides a block diagram of an example transmitter module of an optical transceiver, in accordance with certain embodiments;

FIG. 8 provides a block diagram of an example receiver module of an optical transceiver, in accordance with certain embodiments;

FIG. 9A provides a block diagram of a transceiver including an optical element including a plurality of segmented ring resonators, according to certain embodiments;

FIG. 9B provides a block diagram of an optical interconnect including arrays of HM devices, according to certain embodiments;

FIG. 10 provides a block diagram of an example system that may include one or more optical interconnects including HM devices according to certain embodiments;

FIG. 11 provides a schematic diagram of an example datacenter that may include one or more optical interconnects according to certain embodiments;

FIG. 12 provides a block diagram of two example communication devices in communication with one another according to certain embodiments;

FIGS. 13A and 13B illustrate a top view and a perspective view, respectively, of a transceiver module operatively coupled to a network adapter, in accordance with an embodiment of the disclosure.

FIG. 14 depicts some exemplary scenarios for use of an optical transceiver, in accordance with various embodiments;

FIG. 15 provides a block diagram that schematically illustrates a computing system that may include one or more optical interconnects of various embodiments;

FIG. 16 illustrates an example computing environment, in accordance with at least one embodiment;

FIG. 17 illustrates another example computer system that may include optical interconnects, according to at least one embodiment;

FIG. 18 illustrates an example system including a ring modulator, according to at least one embodiment; and

FIG. 19 is a block diagram that schematically illustrates a co-packaged Networking Device, in accordance with an embodiment that is disclosed herein.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

Various embodiments provide segmented ring resonators, optical elements including segmented ring resonators, optical transceivers including segmented ring resonators, and/or the like. For example, the segmented ring resonators of various embodiments may be incorporated into optical modulators, optical filters, and/or the like.

Conventional ring resonators are a closed ring waveguide. For example, a conventional ring resonator includes a waveguide that is formed in a circle or a closed elliptical ring. Conventional ring resonators tend to be formed using silicon as the waveguide material. Silicon is sensitive to temperature. As such, the resonant wavelength of a conventional silicon ring resonator is thermally tuned (e.g., via application of heat to the ring resonator). This heat is generally electrically generated. For WDM schemes that include a plurality of wavelengths, the electrical power used to thermally tune the ring resonators may be significant.

Silicon nitride (SiN), lithium niobate (LiNbO₃), and barium titanate (BaTiO₃) have thermal refractive coefficients that are ten times or more lower than silicon (Si). For example, the optical performance of SiN, LiNbO₃, and BaTiO₃ with respect to temperature over an operational range of temperatures is significantly more consistent than that of silicon. Therefore, by using SiN, LiNbO₃, or BaTiO₃ (or another material having a lower thermal refractive coefficient than Si) as the waveguide material, the need to thermally tune the resonant wavelength of a ring resonator may be eliminated. As a result, an optical element including a SiN, LiNbO₃, BaTiO₃ ring resonator has a reduced electrical power usage.

However, SiN, LiNbO₃, BaTiO₃ also have refractive indices that are less than that of silicon. In other words, for a SiN, LiNbO₃, or BaTiO₃ ring resonator to not exhibit significant optical loss, the radius of curvature of the SiN, LiNbO₃, or BaTiO₃ ring resonator must be larger than that of conventional silicon ring resonators. For example, conventional ring resonators may have a radius of curvature of five microns but a similar ring resonator formed of SiN. LiNbO₃, or BaTiO₃ requires a radius of curvature of twenty microns. The additional chip space required to accommodate the larger bending radius of a SiN, LiNbO₃, or BaTiO₃ ring resonator is prohibitive. Moreover, ring resonators having larger radii also have a smaller free-spectral range (FSR) (compared to ring resonators having smaller radii), which limits the number of WDM channels available. For example, when the waveguide material is Si, a low loss ring may be formed having a radius of 5 microns, an FSR of 13.7 nm, and a group index of ~4.0. When the waveguide material is SiN, a low loss ring may be formed having a radius of 20 microns, an FSR of 6.8 nm, and a group index of ~2.0. Additionally, the larger the radius of a ring, the greater the thermal mass of the ring. The higher the thermal mass of a ring, the more energy (e.g., electrical power) is consumed to tune the ring to align the ring resonances with the laser wavelength. Therefore, technical challenges exist regarding providing ring resonators and/or optical elements that include ring resonators with reduced electrical power usage.

Various embodiments address these technical challenges by providing a segmented ring resonator that includes two waveguides arcs that are characterized by a large bending radius and that are optically coupled to one another via a pair of reflectors. The resulting segmented ring resonator exhibits low optical loss and does not require thermal tuning. In various embodiments, an optical path of the segmented ring resonator has an optical length that is less than half the circumference of a circle characterized by the radius of curvature. For example, in various embodiments, the segmented ring resonator has an effective ring radius that is three times smaller than would be required by a conventional (e.g., circular) SiN, LiNbO₃, BaTiO₃ ring resonator. For example, replacing a silicon 5 micron radius ring resonator with a conventional SiN ring resonator would require a conventional SiN ring resonator having a 20-30 micron radius. However, the effective ring radius of a segmented ring resonator including SiN ring waveguide segments used to replace the silicon 5 micron radius ring resonator may be 6-8 microns. In other words, the surface area of a substrate occupied by a segmented ring resonator of various embodiments, is significantly smaller than the surface area of the substrate occupied by a conventional (circular) SiN, LiNbO₃, or BaTiO₃ ring resonator. By using thermally stable materials, the resonator requires less or no electrical power for thermal tuning. Thus, various embodiments provide technical improvements to the fields of ring resonators, optical modulators, optical filters, and/or the like.

### Example Segmented Ring Resonator

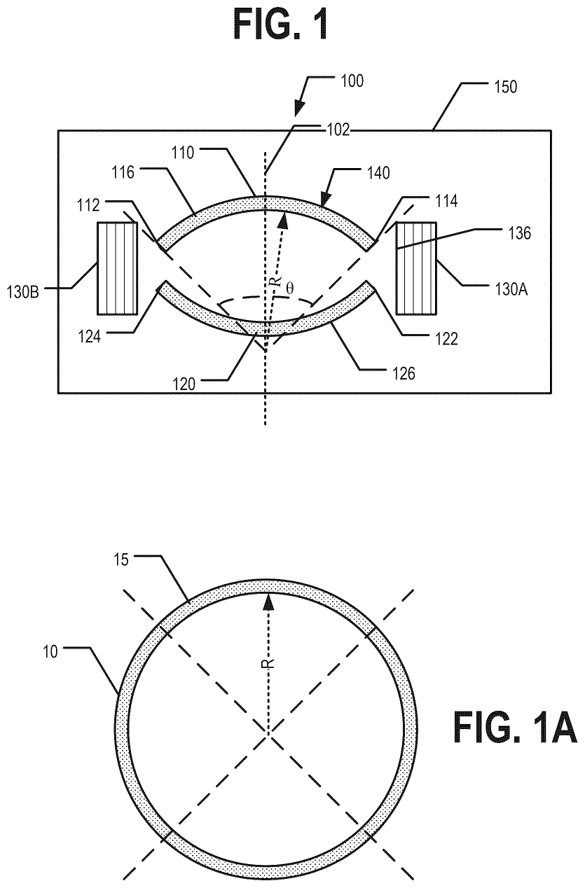

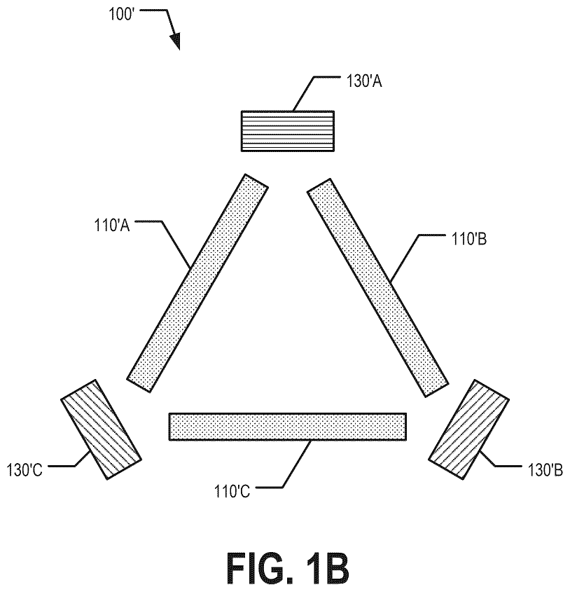

FIG. 1 provides a schematic illustration of an example segmented ring resonator 100. In various embodiments, the segmented ring resonator 100 is formed on a substrate 150. In various embodiments, a segmented ring resonator 100 comprises a first waveguide 110 and a second waveguide 120 that are optically coupled to one another via reflectors 130A, 130B. For example, in certain embodiments, the segmented ring resonator 100 includes a first waveguide 110 formed as a first arc 116 of waveguide material 140 and a second waveguide 120 formed as a second arc 126 of waveguide material 140. A pair of reflectors 130 (e.g., 130A, 130B0 are configured to optically couple respective ends of the first waveguide 110 and the second waveguide 120.

For example, a segmented ring resonator comprises a first waveguide 110 extending from a first waveguide end 112 to a second waveguide end 114 and a second waveguide 120 extending from a third waveguide end 122 to a fourth waveguide end 124. A first reflector 130A optically couples the second waveguide end 114 to the third waveguide end 122. A second reflector 130B optically couples the fourth waveguide end 124 to the first waveguide end 112.

In various embodiments, the waveguide material 140 is Si, SiN, LiNbO₃, BaTiO₃, and/or another waveguide material. In some embodiments, the waveguide material 140 is selected to be substantially stable over an operation range of temperatures. For example, the waveguide material may have a low thermal refractive coefficient (e.g., lower than the thermal refractive coefficient of Si) such that the refractive coefficient of the waveguide material 140 does not change substantially over a range of temperatures at which the segmented ring resonator may be operated.

In various embodiments, the first arc 116 and the second arc 126 are characterized by a radius of curvature R. In some embodiments, the first arc 116 and the second arc 126 are characterized by the same radius of curvature R. In certain embodiments where the waveguide material is SiN, LiNbO₃, or BaTiO₃, the radius of curvature R is in a range of 20 to 40 microns (e.g., 30 microns). In certain embodiments, the first arc 116 and the second are 126 are characterized by an arc angle θ in a range of 15 to 25 degrees (e.g., 20 degrees).

FIG. 1A illustrates a conventional ring resonator 10, which is a closed circular waveguide 15. The circular waveguide 15 is characterized by a radius of curvature R. The optical path of the conventional ring resonator 10 has a physical path length that is the circumference of a circle having radius of curvature R.

The optical path of the segmented ring resonator 100 has a physical path length that is less than the circumference of a circle characterized by the radius of curvature R. As used herein, the effective ring radius of a segmented ring resonator is the radius of a circle having a circumference equal to the physical path length of the segmented ring resonator. The segmented design achieves a much smaller footprint on the chip compared to a conventional low-index-contrast ring. For example, in certain embodiments, the segmented ring resonator 100 has an effective ring radius that is three times smaller than a corresponding conventional ring resonator 10. In other words, the surface area of the substrate 150 required for the segmented ring resonator 100 is significantly smaller than the surface area of a substrate required for a conventional ring resonator 10.

FIG. 1 illustrates a segmented ring resonator 100 comprising two ring waveguide segments (e.g., waveguide 110 and waveguide 120) optically coupled into a closed optical path via two reflectors 130A, 130B. In some embodiments, the segmented ring resonator includes more than two ring waveguide segments and more than two reflectors. For example, a segmented ring resonator may include a plurality of ring waveguide segments where each ring waveguide segment is a waveguide that forms a segment of a ring or closed optical path. The ring waveguide segments may be waveguides formed as an arc characterized by a radius of curvature (as shown in FIG. 1) or may be uncurved waveguides configured as a segment of a ring resonator (as shown in FIG. 1B). The segmented ring resonator further includes a plurality of reflectors configured to couple the plurality of ring waveguide segments into a closed optical path through the plurality of ring waveguide segments. For example, FIG. 1B illustrates another example segmented ring resonator 100′ comprising a plurality of ring waveguide segments 110′ (e.g., 110′A, 110′B, 110′C) and a plurality of reflectors 130′ (e.g., 130′A, 130′B, 130′C). Each reflector 130′ of the plurality of reflectors 130′ is configured to optically couple a pair of ring waveguide segments 110′ of the plurality of ring waveguide segments 110′ to define a closed optical path through the plurality of ring waveguide segments 110′.

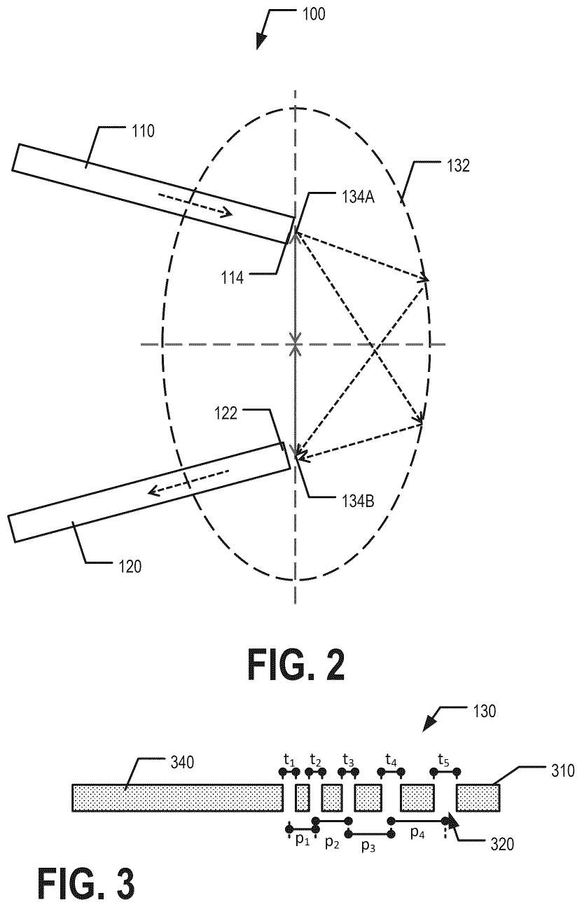

FIG. 2 illustrates an effective reflector surface 132 that represents the mirror properties of the reflectors 130. For example, in various embodiments, the reflectors 130 are effectively confocal ellipses. For example, a waveguide end (e.g., second waveguide end 114) is disposed at a first focal point 134A of the reflector 130. Another waveguide end (e.g., third waveguide end 122) is disposed at a second focal point 134B of the reflector 130. Light provided to the reflector 130 via one of the waveguide ends located at one of focal points 134A diverges as it propagates toward the effective reflector surface 132 and is then reflected of the effective reflector surface 132 such that the light is focused onto the other focal point 134B where the light is coupled into one of the waveguide arcs via a respective waveguide end.

In various embodiments, the reflectors 130 are configured to satisfy one or more phase conditions. For example, the one or more phase conditions may be configured to cause the reflectivity of the reflectors 130 to be optimized. In some embodiments, the one or more phase conditions are configured to cause the ring resonator to maintain or experience resonance for a selected wavelength. In an example embodiment, one or both of the reflectors 130 are Bragg reflectors and one of the phase conditions corresponds to a reflectivity of the Bragg reflector increasing adiabatically with a distance into the Bragg reflector from a front surface 136 of the Bragg reflector. For example, the Bragg reflector may be an apodized Bragg reflector (e.g., a Bragg reflector engineered and/or designed using an apodization technique) where the coupling coefficient increases gradually with distance into the Bragg reflector. This coupling coefficient increase is caused by gradually increasing the width of the alternating layers of the Bragg reflector. For example, the grating teeth widths increase gradually, which reflect light stronger and stronger while avoiding abrupt change in the effective indices experienced by the light (which would cause scattering light out of the plane and cause excess loss).

In various embodiments, the one or more phase conditions includes a one-dimensional phase matching condition. For example, a Bragg reflector comprises an array of trenches and each trench reflects a small amount of incident light. The trench widths and spacings or pitch widths of the Bragg reflector are configured such that the reflection from all of the trenches have the same phase modulo 2π. For example, according to the one-dimensional phase matching condition, if the reflection from the first trench has a phase φ, the reflection from the second trench has a phase of φ+2π, the reflection from the third trench has a phase of φ+4π, etc., such that the reflections off of each of the trenches add up coherently (e.g., constructively interfere) to achieve maximum reflectivity.

In various embodiments, the one or more phase conditions includes a two-dimensional phase matching condition. As shown in FIG. 2, light exiting a waveguide to the slab (e.g., of the reflector 130) has a large divergence angle (e.g., generally 30-40 degrees in a Si or SiN platform) and different rays will be reflected by different parts of the Bragg reflector. According to the two-dimensional phase matching condition, the shapes of the trenches are selected to be a family of confocal (partial) ellipses. The phase difference of all rays propagating from one focal point to the other focal point will be zero, which enable maximum focusing of the light into the optically coupled waveguide.

In various embodiments, one or both of the reflectors 130 are Bragg reflectors. Bragg reflectors comprise alternating layers or grating lines characterized by different refractive indices. For example, as illustrated in FIG. 3, the reflectors 130 may comprise ridges 310 of a first material 340 having trenches 320 formed and/or etched therebetween. In some embodiments, the first material 340 is the same material as the waveguide material 140. In some embodiments, the first material 340 is a different material than the waveguide material 140. In some embodiments, the trenches 320 are filled with air or vacuum and/or do not have a material disposed therein. In an example embodiment, a second material (having a different refractive index than the first material 340) is disposed within the trenches 320.

In various embodiments, a Bragg reflector is characterized by the respective refractive indices of the alternating layers, the trench widths (e.g., t₁, t₂, t₃, t₄, t₅, and/or the like) and the pitch widths (e.g., p₁, p₂, p₃, p₄, and/or the like), an eccentricity of the layers, and the number of alternating layers. As should be understood, the trench width is the width of a trench 320 in a plane parallel to the surface of the substrate 150 and the pitch width is the distance or spacing between adjacent features, layers, or ridges 310 of the Bragg reflector. As shown in FIG. 3, the pitch width is measured from the center of one trench 320 to the center of the adjacent trench. In some embodiments, a Bragg reflector includes five to fifteen trenches. For example, the trench widths and/or the pitch widths may be configured to satisfy a one-dimensional phase matching condition.

In some embodiments, the trench widths and/or the pitch widths of a reflector 130 are consistent and/or uniform across the reflector 130. In certain embodiments, the trench widths and/or pitch widths may evolve and/or change across the reflector 130. For example, the trench widths and/or pitch widths may evolve across the reflector 130 (e.g., with increasing distance into the reflector 130 from the front surface 136) such that the reflectivity of the reflector 130 increases adiabatically with increasing distance into the reflector 130 from the front surface 136.

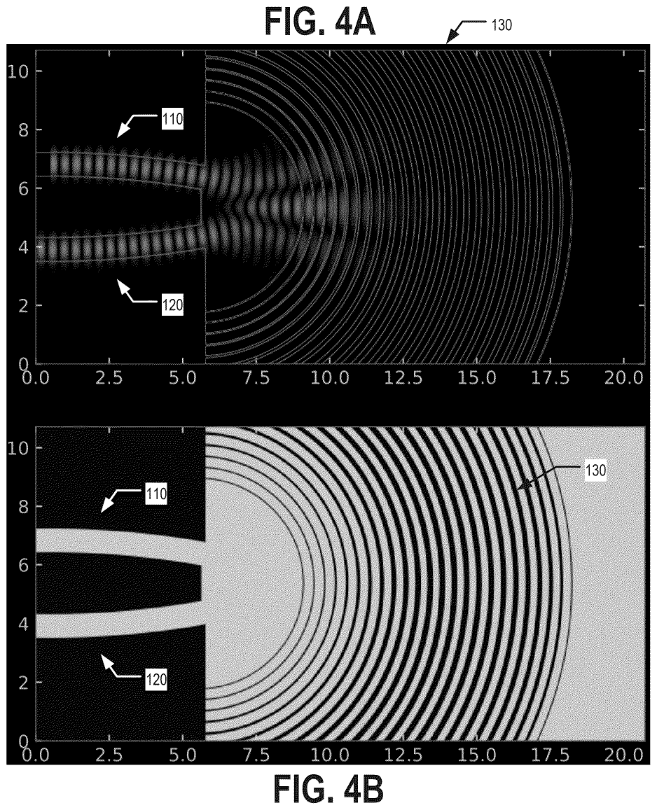

FIG. 4A illustrates a simulated electric field profile of a reflector 130 during operation of a segmented ring resonator and FIG. 4B illustrates the geometry of the reflector 130 used for the simulation. In various embodiments, the ridges 310 and/or trenches 320 of a reflector 130 are partial confocal ellipses. In some embodiments each of ridges 310 and/or trenches 320 is a confocal ellipse having a respective eccentricity. The eccentricity of the ridges 310 and/or trenches 320 may be different from one another and/or individually determined. For example, the eccentricity of the ridges 310 and/or trenches 320 may be configured to satisfy the two-dimensional phase matching condition.

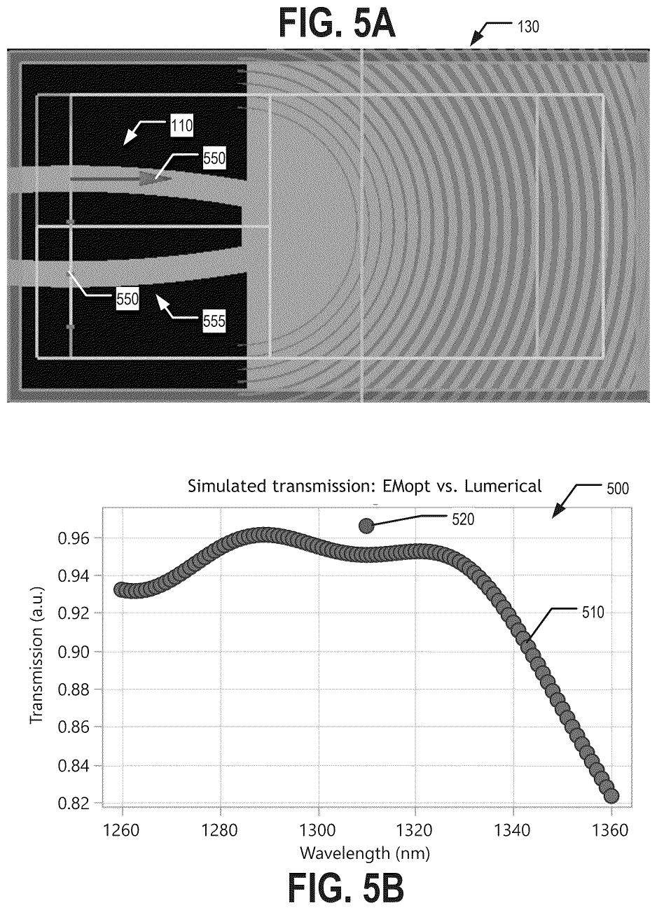

FIG. 5A illustrates a configuration used to perform a lumerical simulation of a portion of a segmented ring resonator 100. The simulation includes providing a source beam 550 via a first waveguide 110 and measuring the transmission of the source beam 550 from the first waveguide 110 through to monitoring point 555 in the second waveguide 120 (e.g., via reflector 130).

FIG. 5B provides a plot 500 showing the results 510 of the lumerical simulation as a function of wavelength and results 520 of an EM optical simulation for an optical signal characterized by 1310 nm. As can be seen in FIG. 5B, the half ring transmission spectra is broadband. For example, transmission of optical signals characterized by wavelengths within a range of about 1270 nm to 1335 nm is 0.94 or higher.

While FIGS. 2, 4A, 4B, and 5A show the first reflector 130A, the second reflector 130B may be similarly configured. For example, the second reflector 130B may be designed and/or configured as a mirror of the first reflector 130A (e.g., across a symmetry axis 102 of the segmented ring resonator 100), in some embodiments.

### Example Optical Element Including a Segmented Ring Resonator

In various embodiments, a segmented ring resonator 100 may be part of an optical element. In various embodiments, an optical element includes a segmented ring resonator 100 and through waveguide that is evanescently coupled to the segmented ring resonator 100 (e.g., first waveguide 110 and/or second waveguide 120). The optical element may be a modulator, filter, or other optical element that uses the optical resonance of the segmented ring resonator to perform an optical function.

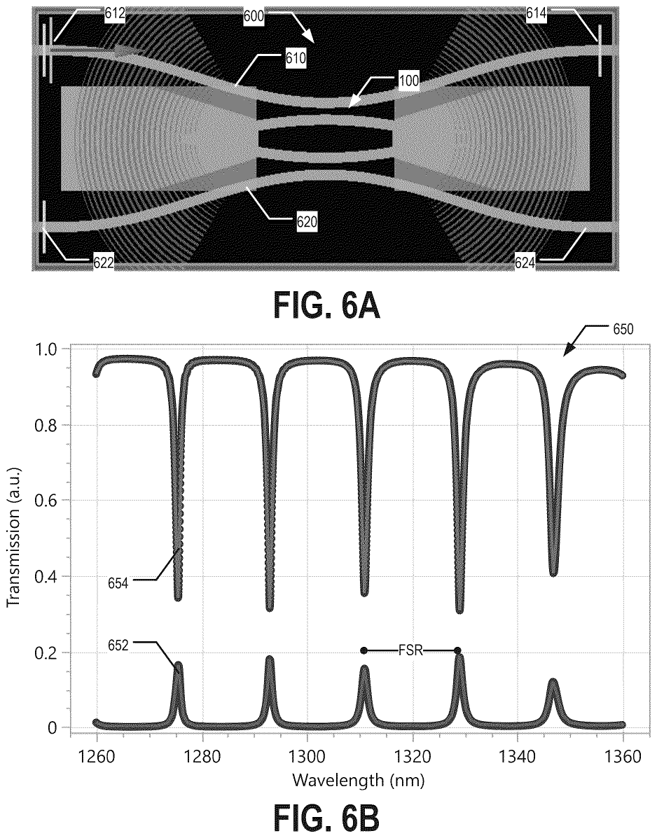

FIG. 6A illustrates the geometry of a simulation of an example optical element 600. The optical element 600 includes a segmented ring resonator 100, a first through waveguide 610 and a second through waveguide 620. The first through waveguide 610 is evanescently coupled to the first waveguide 110 of the segmented ring resonator 100 and the second through waveguide 620 is evanescently coupled to the second waveguide 120. The first through waveguide 610 and the second through waveguide 620 are coupled to one another via the segmented ring resonator 100 and are not directly coupled to one another.

In the simulation, an optical beam is provided via an end 612 of the first through waveguide 610. The opposite end 614 of the first through waveguide 610 was simulated as a through port and transmission therethrough is measured and/or monitored. Transmission through an end 622 of the second through waveguide 620 is monitored and/or measured. End 624 of the second through waveguide 620 was treated as an open end in the simulation.

FIG. 6B illustrates a plot 650 that illustrates the transmission curve 654 of optical signals through the first through waveguide 610 (e.g., measured at end 614) as a function of wavelength and transmission curve 652 of optical signals through the second through waveguide 620 (e.g., measured at end 622 and/or end 624). Dips in the transmission curve 654 and peaks in the transmission curve 652 correspond to frequencies where the optical signal is resonant with the example segmented ring resonator 100 and therefore the segmented ring resonator 100, via the respective evanescent couplings, transferred the optical energy from the first through waveguide 610 to the second through waveguide 620. For optical signals characterized by wavelengths that are not resonant with the example segmented ring resonator 100, the optical signal is not coupled into the second through waveguide 620 from the first through waveguide 610 via the segmented ring resonator 100.

In the example embodiment corresponding to the illustrated simulation results, the resonant dips and peaks are separated from one another by a free spectral range (FSR) of the segmented ring resonator 100. In the illustrated embodiment, the FSR is 17.98 nm and the segmented ring resonator 100 has an effective radius of 7.6 microns.

### Example Optical Transceiver Including Segmented Ring Resonators

Various embodiments provide optical transceivers that include one or more segmented ring resonators. In some embodiments, the optical transceivers are configured to for communicating multi-wavelength and/or multiple channel optical signals. For example, the optical transceivers may be configured to operate using a WDM scheme, such as coarse WDM or dense WDM.

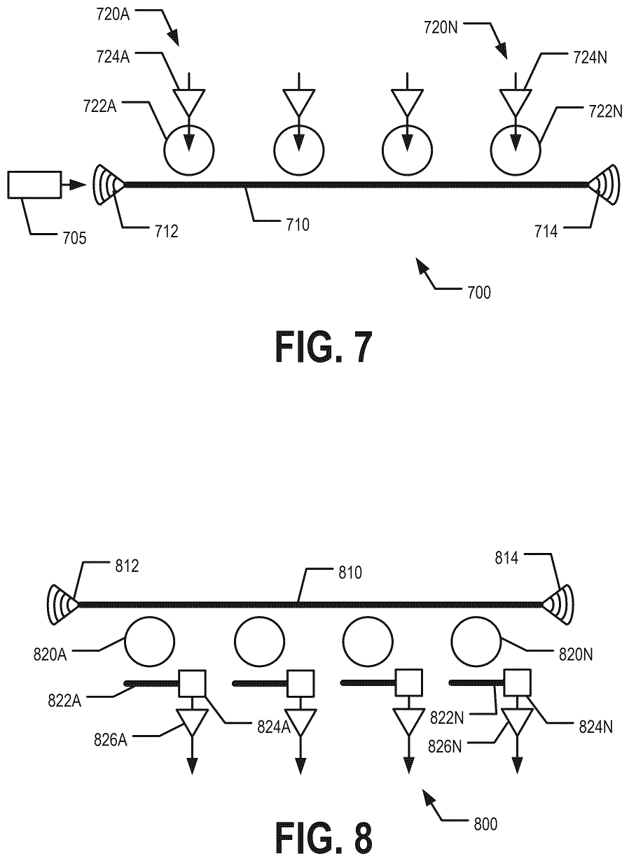

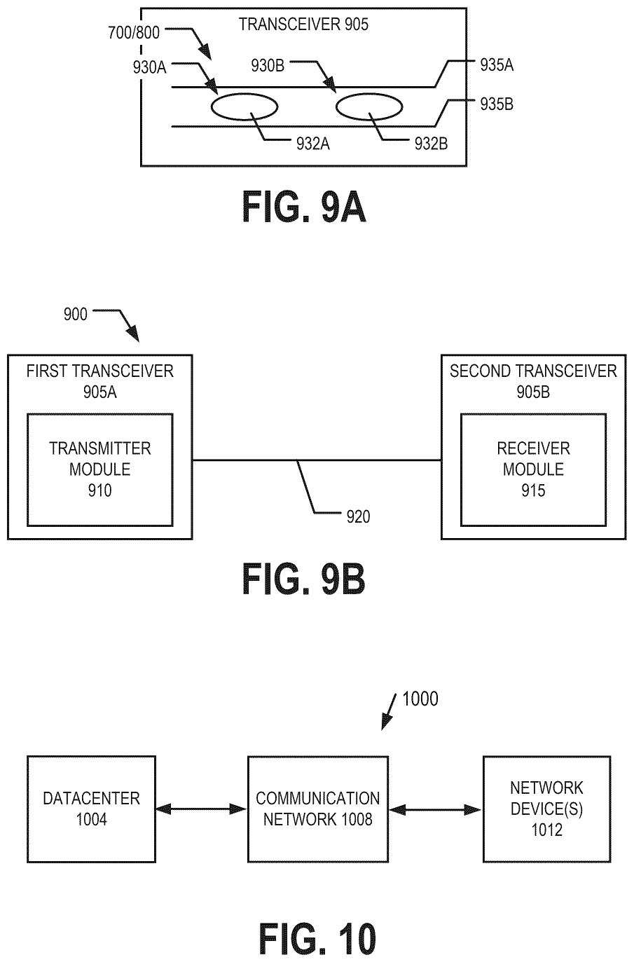

In various embodiments, an optical transceiver comprises one or more transmitter modules 700, an example of which is illustrated in FIG. 7, and/or one or more receiver modules 800, an example of which is illustrated in FIG. 8. An optical transceiver is configured to be in optical communication with another optical transceiver via one or more optical fibers (see e.g., FIG. 9) so as to provide optical communication between the two optical transceivers.

FIG. 7 illustrates an example transmitter module 700 comprising segmented ring resonators 722A-722N. The transmitter module 700 includes an optical source 705. In various embodiments, the optical source 705 is a frequency comb laser such as a colliding pulse mode-locked (CPM) laser. In some embodiments, the optical source 705 is a multi-wavelength laser configured generate an optical signal comprising a plurality of distinct spectral lines. In some embodiments, the optical source 705 is an array of single wavelength lasers each configured to generate a respective spectral line. The multi-wavelength optical signal generated by the optical source is coupled into a (through) waveguide 710 via optical coupler 712.

A plurality of optical modulators 720 (e.g., 720A-720N) are configured to modulate respective spectral lines of the multi-wavelength optical signal to encode respective streams of data onto the respective spectral lines. Each optical modulator 720 includes a segmented ring resonator 722 (e.g., 722A-722N) that is evanescently coupled to the waveguide 710. Each segmented ring resonator 722 is resonant with a respective spectral line of the multi-wavelength optical signal. For example, each segmented ring resonator 722 defines a different optical path length such that each segmented ring resonator 722 is resonant with a different spectral line of the multi-wavelength optical signal.

Each optical modulator 720 also include a driver 724 (e.g., 724A-724N). In some embodiments, the driver 724 is a complementary metal-oxide-semiconductor (CMOS) driver. In various embodiments, the driver 724 of an optical modulator 720 is configured to control when a spectral line that is resonant with the segmented ring resonator 722 of the optical modulator 720 is or is not coupled into the segmented ring resonator 722. For example, the optical modulator 720 may be a ring-resonator modulator (RRM). In various embodiments, each optical modulator 720 is configured to modulate a different spectral line of the multi-wavelength optical signal.

As a result of the plurality of optical modulators 720 evanescently coupled to the waveguide 710, the respective spectral lines of the multi-wavelength optical signal are modulated to encode respective data signals. The multi-wavelength optical signal is then provided to optical coupler 714. The optical coupler 714 may couple the multi-wavelength optical signal into an optical fiber and/or the like, such that the multi-wavelength optical signal (including N optical channels each corresponding to a respective spectral line) may be transmitted to a receiver module so as to communicate the streams of data encoded therein to the receiver.

FIG. 8 illustrates an example receiver module 800 including segmented ring resonators 820A-820N. In an example embodiment, optical coupler 812 couples a multi-wavelength optical signal into a (through) waveguide 810. For example, the optical coupler 812 may couple an optical signal received via an optical fiber and/or the like into the waveguide 810.

A plurality of segmented ring resonators 820 evanescently couple the waveguide 810 to respective stub waveguides 822 (e.g., 822A-822N). For example, the segmented ring resonators 820 act as optical filters that are each configured to couple a respective spectral line of the multi-wavelength optical signal from the waveguide 810 to the respective stub waveguide 822. For example, each segmented ring resonator 820 defines a different optical path length such that each segmented ring resonator 820 is resonant with a different spectral line of the multi-wavelength optical signal.

The stub waveguide 822 provides the spectral line (having a stream of data encoded thereon) to a respective photodetector 824 (e.g., 824A-824N). For example, the segmented ring resonator 820 is configured to isolate the respective spectral line into the stub waveguide 822. The photodetector 824 generates an electrical signal indicative of the intensity, optical power, and/or changes therein of the spectral line provided to the photodetector 824 via the stub waveguide 822 and segmented ring resonator 820. The electrical signal generated by a photodetector 824 is provided to respective receiver circuitry 826 (e.g., 826A-826N). In an example embodiment, the receiver circuitry 826 includes a CMOS receiver.

In an example embodiment, the optical coupler 814 provides any signal remaining in the waveguide 810 after the segmented ring resonators 820 have been used to pick off and/or isolate respective spectral lines into respective stub waveguides 822 to a photodetector and/or the like to monitor noise present in the optical link including the receiver module 800.

### Example Optical Interconnect Including Segmented Ring Resonators

FIG. 9B illustrates an example optical interconnect 900 including one or more segmented ring resonators 100, 100′ of various embodiments. As should be understood, segmented ring resonators of various embodiments may be incorporated into a variety of components, assemblies, and/or systems. Optical interconnects including one or more segmented ring resonators of various embodiments are illustrated herein to provide an example of on such component, assembly, and/or system in which segmented ring resonators of various embodiments may be incorporated.

The optical interconnect 900 comprises a first transceiver 905A and a second transceiver 905B. The first transceiver 905A is in optical communication with the second transceiver 905B via one or more optical fibers 920. The first transceiver 905A comprises one or more transmitter modules 910. For example, a transmitter module 910 may be similar to a transmitter module 700. In various embodiments, the one or more transmitter modules are each configured to generate and provide coarse or dense WDM optical signals.

The second transceiver 905B comprises one or more receiver modules 915. In various embodiments, a receiver module 915 includes an optical filter including a segmented ring resonator, secondary waveguides evanescently coupled to respective segmented ring resonators so as to receive isolated spectral line optical signals therefrom, and photodetectors configured to generate respective electrical signals based on respective isolated spectral line optical signals. For example, receiver module 915 may be similar to a receiver module 800.

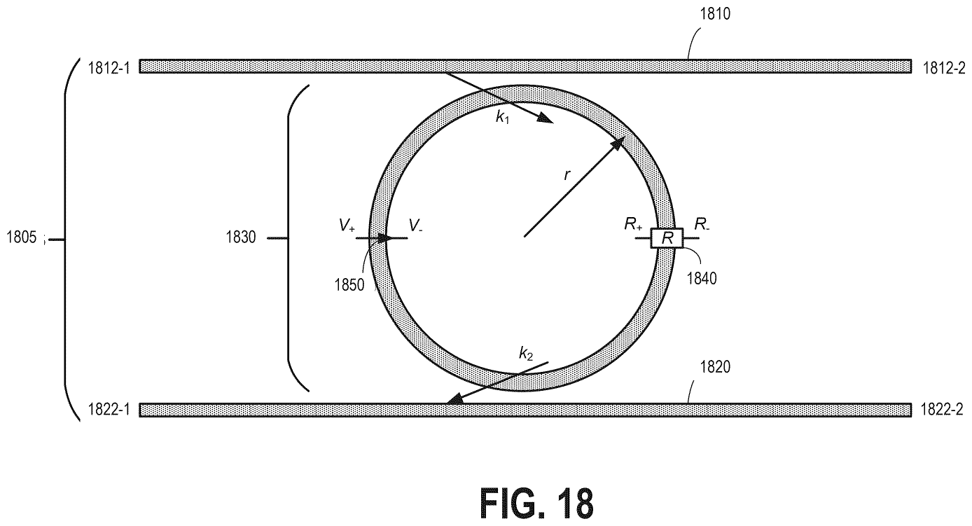

For example, a transceiver 905 may include a transmitter module 910 similar to transmitter module 700 and/or a receiver module 915 similar to receiver module 800, for example. For example, as shown in FIG. 9A, the transceiver 905 may include a first optical element 930A comprising a first segmented ring resonator 932A and a second optical element 930B comprising a second segmented ring resonator 932B. For example, each optical element of one or more optical elements of the transceiver 905 may include a segmented ring resonator. The segmented ring resonator includes a plurality of ring waveguide segments, and a plurality of reflectors. Each reflector of the plurality of reflectors is configured to optically couple a pair of ring waveguide segments of the plurality of ring waveguide segments to define a closed optical path through the plurality of ring waveguide segments. The transceiver 905 further includes one or more through waveguides 935A, 935B that is evanescently coupled to the segmented ring resonator 932A, 932B of at least one optical element 930A, 930B of the one or more optical elements. For example, the one or more through waveguide 935A, 935B may be arranged in similar relationship with the segmented ring resonators 932 of the optical elements 930 in a manner similar to that illustrated by and discussed in relation to FIG. 6A and FIG. 18. The optical element may be a respective one of a modulator or an optical filter.

Returning to FIG. 9B, the first transceiver 905A comprises one or more frequency comb laser sources, for example, that generate and provide frequency comb laser pulses and, via optical modulators comprising respective segmented ring resonators, one or more teeth or spectral lines of the frequency comb laser pulse are modulated to provide an optical signal having, possibly, multiple channels of data encoded therein. The optical signal is then provided to the second transceiver 905B via the optical fiber 920, for example. The receiver module 915 may use optical filters comprising respective segmented ring resonators to isolate respective teeth or spectral lines of the optical signal and provide the isolated teeth or spectral lines to respective optical signal detecting components that may include respective photodiodes and/or other photodetectors. The optical signal detecting components may receive and/or detect respective portions of the optical signal (e.g., corresponding to respective teeth of spectral lines of the frequency comb laser pulse) such that information is communicated from the first transceiver 905A to the second transceiver 905B via the optical signal(s).

### Example Datacenter

In various embodiments, a system includes an optical element that includes a segmented ring resonator of an example embodiment. For example, the segmented ring resonator may be part of an optical modulator, optical filter, and/or other optical element configured to use the segmented ring resonator to provide an optical function. For example, as shown in FIGS. 7 and 8, segmented ring resonators of various embodiments may be incorporated into transmitter modules 700 and/or receiver modules 800 of optical interconnects. Such an optical interconnect may be part of a datacenter.

For example, an optical interconnect of various embodiments may be used to place various components of a datacenter in communication with one another. In various embodiments, the system may include a pluggable optical interconnect, a chip-to-chip optical interconnect, an optical network comprising a plurality of optical interconnect, dense Wavelength Division Multiplexing (WDM) optical links, WDM or DWDM source and/or the like.

Datacenters may include multiple network switches in a particular topology, such as a fat tree topology, a slim fly topology, a dragonfly topology, and/or the like. The specifications and makeup of the network switches in the topology affects the overall network performance (e.g., bandwidth capability) of the datacenter.

Datacenters are the storage and data processing hubs of the internet. The massive deployment of cloud applications is causing datacenters to expand exponentially in size, stimulating the development of faster switches than can cope with the increasing data traffic inside the datacenter. Current state-of-the-art switches are capable of handling 12.8 Tb/s of traffic by employing electrical switches in the form of application specific integrated circuits (ASICs) equipped with 256 data lanes, each operating at 50 Gbps. Such switching ASICs typically consume as much as 400 W, and the power consumption of the optical transceiver interfaces attached to each ASIC is comparable. To keep pace with traffic demand, switch capacity doubles approximately every two years. To date, this rapid scaling has been made possible by exploiting advances in manufacturing (e.g., CMOS techniques), collectively described by Moore's law (i.e., the observation that the number of transistors in a dense integrated circuit doubles about every two years). However, in recent years there are strong indications of Moore's law slowing down, which raises concerns about the capability to sustain the target scaling rate of switch capacity. As a result, alternative technologies are being investigated.

FIG. 10 illustrates a system 1000 according to at least one example embodiment. The system 1000 includes a datacenter 1004, a communication network 1008, and one or more network devices 1012. In at least one example embodiment, the datacenter 1004 corresponds to a collection of network devices, such as network switches (e.g., Ethernet switches) connected with a collection of servers or compute nodes. The datacenter 1004 may adhere to a networking topology (e.g., a hierarchal networking topology), such as a fat tree topology, a Slim Fly topology, a Dragonfly topology, and/or the like. The datacenter 1004 routes traffic amongst the network switches and servers therein, and at least one layer of the topology in the datacenter 1004 is coupled to the communication network 1008 to allow networking traffic to flow between the datacenter 1004 and the network device(s) 1012.

Examples of the communication network 1008 that may be used to connect the datacenter 1004 and the network device(s) 1012 include an Internet Protocol (IP) network, an Ethernet network, an InfiniBand (TB) network, a Fibre Channel network, the Internet, a cellular communication network, a wireless communication network, combinations thereof (e.g., Fibre Channel over Ethernet), variants thereof, and/or the like.

The one or more network devices 1012 may include switch, router, or Network Interface Controller (NIC), interconnect using ports, one or more of Personal Computer (PC), a laptop, a tablet, a smartphone, a server, a collection of servers, and/or any suitable computing device for sending and receiving signals over the communication network 1008. In at least one example embodiment, the one or more network devices 1012 correspond to another datacenter, similar to or the same as datacenter 1004.

As noted above, the datacenter 1004 and/or the network device(s) 1012 may include storage devices and/or processing circuitry for carrying out computing tasks, for example, tasks associated with controlling the flow of data internally and/or over the communication network 1008. Such processing circuitry may comprise software, hardware, or a combination thereof. For example, the processing circuitry may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory).

Additionally or alternatively, the processing circuitry may comprise hardware, such as an application specific integrated circuit (ASIC). For example, the processor may be or include one or more of an Integrated Circuit (IC) chip, a microprocessor, a Central Processing Unit (CPU), a Graphics Processing Unit (GPU), a Data Processing Unit (DPU), a Field Programmable Gate Array (FPGA), a network interface controller (NIC), an ASIC, combinations thereof, and the like. The processing circuitry may comprise an ASIC and/or may be capable of performing as a central processing unit (CPU), a graphics processing unit (GPU), a network interface controller (NIC), a data processing unit (DPU), or any other computing device in which data is received and/or transmitted.

Some or all of the processing circuitry may be provided on a Printed Circuit Board (PCB) or collection of PCBs. It should be appreciated that any appropriate type of electrical component or collection of electrical components may be suitable for inclusion in the processing circuitry.

In addition, although not explicitly shown, it should be appreciated that the datacenter 1004 and network device(s) 1012 may include one or more communication interfaces for facilitating wired and/or wireless communication between one another and other unillustrated elements of the system 1000.

In related art systems, a fat tree topology may use the same electrical switching devices on all layers (edge, aggregation, core). For example, each switching device may be 1 U switch, where 1 U refers to the industry standard size for rack-mounted switch and/or server. The interconnection between switches of different layers may be accomplished with optical links or optical interconnects using active optical cables and optical transceivers implemented in a pluggable form factor (also referred to as “pluggables”).

Optical Datacenter Networks rely on allocation and deallocation of light paths from the data sources to the destinations end-ports to guarantee no light collisions and data loss occur in the fabric. Traditionally the allocation algorithms are run from a central entity which considers the entire demand for source and destination flows and try to find the most dense mapping of these demands to network resources over a single or multiple time periods.

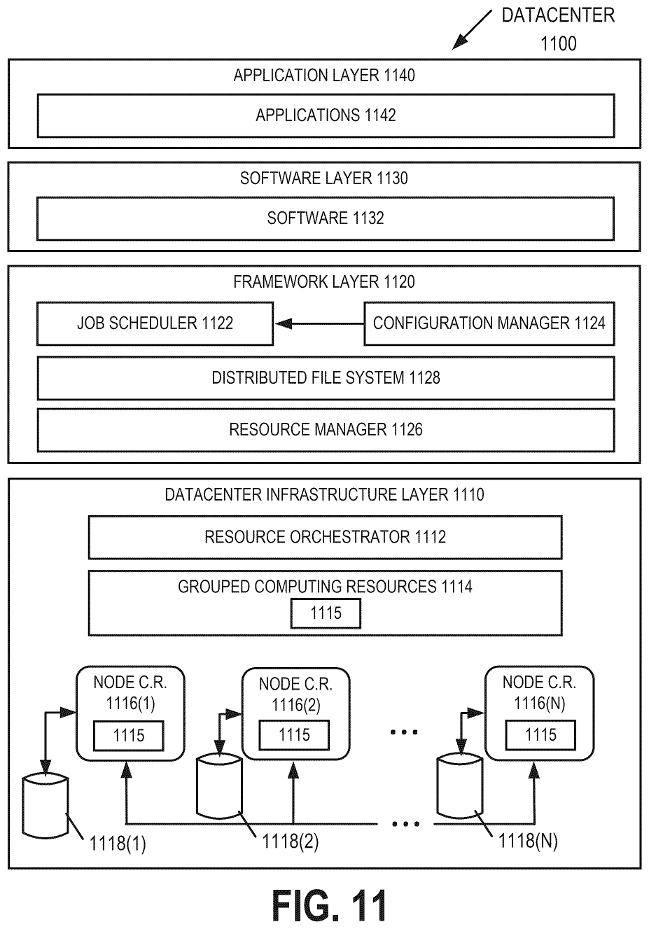

FIG. 11 illustrates an example datacenter 1100, in which at least one embodiment may be used. In at least one embodiment, datacenter 1100 includes a datacenter infrastructure layer 1110, a framework layer 1120, a software layer 1130, and an application layer 1140.

In at least one embodiment, as shown in FIG. 11, datacenter infrastructure layer 1110 may include a resource orchestrator 1112, grouped computing resources 1114, and node computing resources (“node C.R.s”) 1116(1)-1116(N), where “N” represents a positive integer (which may be a different integer “N” than used in other figures). In at least one embodiment, node C.R.s 1116(1)-1116(N) may include, but are not limited to, any number of central processing units (“CPUs”) or other processors (including accelerators, field programmable gate arrays (FPGAs), graphics processors, etc.), memory storage devices 1118(1)-1118(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 1116(1)-1116(N) may be a server having one or more of above-mentioned computing resources.

In at least one embodiment, grouped computing resources 1114 may include separate groupings of node C.R.s housed within one or more racks (not shown), or many racks housed in datacenters at various geographical locations (also not shown). In at least one embodiment, separate groupings of node C.R.s within grouped computing resources 1114 may include grouped compute, network, memory, or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 1112 may configure or otherwise control one or more node C.R.s 1116(1)-1116(N) and/or grouped computing resources 1114. In at least one embodiment, resource orchestrator 1112 may include a software design infrastructure (“SDI”) management entity for datacenter 1100. In at least one embodiment, resource orchestrator 1112 may include hardware, software or some combination thereof.

In at least one embodiment, as shown in FIG. 11, framework layer 1120 includes a job scheduler 1122, a configuration manager 1124, a resource manager 1126 and a distributed file system 1128. In at least one embodiment, framework layer 1120 may include a framework to support software 1132 of software layer 1130 and/or one or more application(s) 1142 of application layer 1140. In at least one embodiment, software 1132 or application(s) 1142 may respectively include web-based service software or applications, such as those provided by Amazon Web Services, Google Cloud and Microsoft Azure. In at least one embodiment, framework layer 1120 may be, but is not limited to, a type of free and open-source software web application framework such as Apache Spark™ (hereinafter “Spark”) that may utilize distributed file system 1128 for large-scale data processing (e.g., “big data”). In at least one embodiment, job scheduler 1122 may include a Spark driver to facilitate scheduling of workloads supported by various layers of datacenter 1100. In at least one embodiment, configuration manager 1124 may be capable of configuring different layers such as software layer 1130 and framework layer 1120 including Spark and distributed file system 1128 for supporting large-scale data processing. In at least one embodiment, resource manager 1126 may be capable of managing clustered or grouped computing resources mapped to or allocated for support of distributed file system 1128 and job scheduler 1122. In at least one embodiment, clustered or grouped computing resources may include grouped computing resources 1114 at datacenter infrastructure layer 1110. In at least one embodiment, resource manager 1126 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1128 of framework layer 1120. In at least one embodiment, one or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1128 of framework layer 1120. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 1124, resource manager 1126, and resource orchestrator 1112 may implement any number and type of self-modifying actions based on any amount and type of data acquired in any technically feasible fashion. In at least one embodiment, self-modifying actions may relieve a datacenter operator of datacenter 1100 from making possibly bad configuration decisions and possibly avoiding underutilized and/or poor performing portions of a datacenter.

In at least one embodiment, datacenter 1100 may include tools, services, software, or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to datacenter 1100. In at least one embodiment, trained machine learning models corresponding to one or more neural networks may be used to infer or predict information using resources described above with respect to datacenter 1100 by using weight parameters calculated through one or more training techniques described herein.

In at least one embodiment, datacenter may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 1115 are used to perform inferencing and/or training operations associated with one or more embodiments. In at least one embodiment, inference, and/or training logic 1115 may be used in system FIG. 11 for inferencing or predicting operations based, at least in part, on weight parameters calculated using neural network training operations, neural network functions and/or architectures, or neural network use cases described herein.

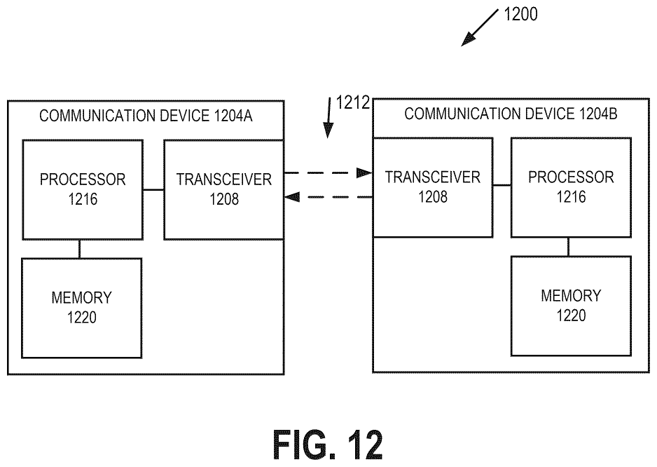

FIG. 12 illustrates a system 1200 including a first communication device 1204A and a second communication device 1204B. Illustratively, but without limitation, the communication devices 1204 (e.g., 1204A, 1204B) may correspond to network devices (e.g., network devices 1012). As such, the communication devices 1204 may correspond to any type of device that becomes part of or is connected with a communication network (e.g., communication network 1008). Examples of suitable devices that may act or operate like a communication device 1204 as described herein include, without limitation, one or more of a Personal Computer (PC), a laptop, a tablet, a smartphone, a server, a collection of servers, a networking card, an edge router, a switch, Network Interface Controller, a Top of Rack (ToR) switch, a server blade, or the like. The communication device 1204 may include a transceiver 1208, a processor 1216, and memory 1220. The transceiver 1208 may include hardware that enables communications over the communication channel 1212 whereas the processor 1216 and memory 1220 may include components that enable the communication device 1204 to provide a desired functionality or perform certain functions.

The communication channel 1212 may traverse a datacenter or any type of communication network (whether trusted or untrusted). Examples of a communication network that may be used to connect communication devices 1204 and support the communication channel 1212 include, without limitation, an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. In one specific, but non-limiting example, the communication network enables data transmission between the communication devices 1204 using optical signals. In this case, the communication devices 1204 and the communication network may include waveguides (e.g., optical fibers) that carry the optical signals. For example, the communication devices and/or the communication network may include one or more segmented ring resonators 100, 100′, according to various embodiments.

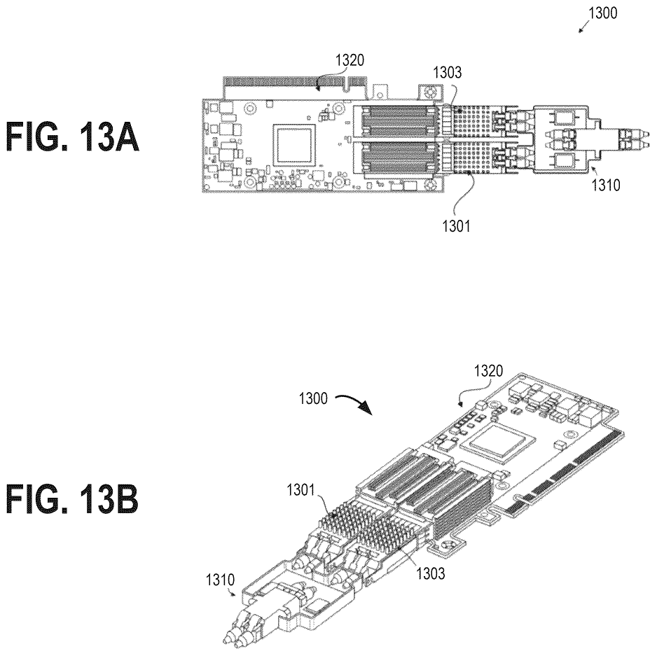

FIGS. 13A and 13B illustrate a top view and a perspective view, respectively, of a transceiver module operatively coupled to a network adapter, in the present example a Network Interface Controller (NIC) 1300, in accordance with an embodiment of the disclosure. As shown in FIGS. 13A and 13B, the transceiver module may include a first optical module 1301, a second optical module 1303, an adapter 1310, and a dual-port NIC 1320 of a server. Both the first optical module 1301 and the second optical module 1303 may be dual-fiber transceivers that are configured for duplex communication that allows the source (e.g., server) to communicate with the target (e.g., leaf switch) in both directions. The adapter 1310 may be a ganged physical component configured to link the first optical module 1301 and the second optical module 1303 for the purpose of transmitting and receiving data to and from the leaf switch.

In some embodiments, the adapter 1310 may be configured to operate in two configurations, such as a first configuration and a second configuration. In one aspect, the first configuration may be a default configuration of operation, where the first optical module 1301 may be operationally active. The second configuration may be a contingent configuration that is implemented when the first optical module 1301 operationally fails. When such a failure is detected, the second optical module 1303, which is otherwise operationally inactive or idle, may be engaged to become operationally active and handle all network traffic that was initially handled by the first optical module 1301.

In some embodiments, the transceiver module 1300 may be configured to operate in a leaf-spine architecture. A leaf-spine architecture is a data center network topology that may include two switching layers—a spine layer and a leaf layer. The leaf layer may include access switches (leaf switches) that aggregate traffic from servers and connect directly into the spine or network core. Spine switches interconnect all leaf switches in a full-mesh topology between access switches in the leaf layer and the servers from which the access switches aggregate traffic. As such, in one embodiment, to ensure reliable operation of downlinks, the transceiver module 1300 may be configured to operate between the server and the leaf layer. In particular, as shown in FIGS. 13A and 13B, the adapter 1310 may be operatively coupled to the first optical module 1301 and the second optical module 1303, while the first optical module 1301 and the second optical module 1303 may be operatively coupled to a dual-port NIC 1320 of a server.

In embodiments, NIC 1300 may comprise one or more processing circuits, as detailed above; the processing circuits may comprise FW, that is loaded according to the techniques described above.

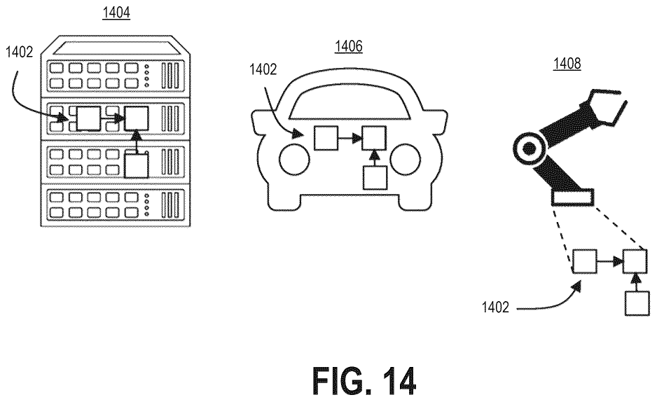

FIG. 14 depicts some exemplary scenarios for use of an optical transceiver 1402 in accordance with some embodiments. An optical transceiver 1402 may be utilized in a computing system 1404 (e.g., in a server farm, or within a server computer system), a vehicle 1406 (e.g., a car, truck, train, or airplane), and a robot 1408 (or among robots in a factory), to name just a few examples. The optical transceiver 1402 may be particularly useful for high-speed communication in environments subject to high levels of electromagnetic interference (EMI).

### Example System Use Case

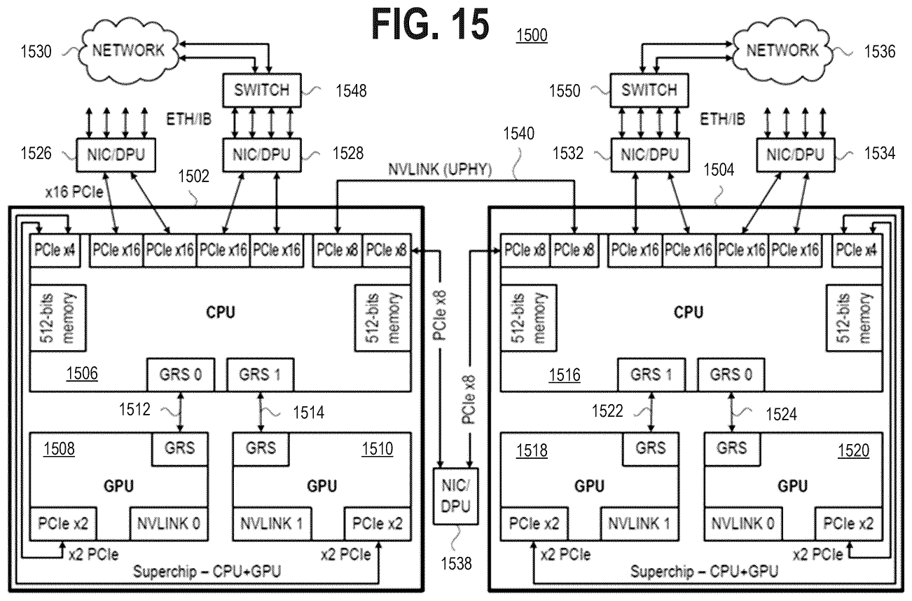

FIG. 15 is a block diagram that schematically illustrates a computing system 1500, e.g., a data center or a High-Performance Computing (HPC) cluster, in accordance with an embodiment that is described herein. System 1500 comprises a plurality of subsystems, e.g., multiple processing devices coupled to each other, multiple network devices, and multiple networks, according to at least one embodiment. Computing system 1500 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1500 and to one or more external networks 1530, 1536. In the present example, system 1500 comprises a packet switch 1548 that connects NIC/DPU 1528 to network 1530, and a packet switch 1550 that connects NIC/DPU 1532 to network 1536.

The coupling of processing devices through NVLink allows for seamless data exchange and parallel processing, enhancing overall computational performance. The processing devices are connected to multiple networks through one or more network interface controllers (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1500 can include one or more CPUs and one or more GPUs.

FIG. 15 also demonstrates an example architecture of a multi-GPU architecture. As illustrated in the figure, computing system 1500 includes a processing device 1502 with a multi-GPU architecture. In particular, processing device 1502 may be a system-on-chip and includes multiple subsystems such as a CPU 1506, a GPU 1508, and a GPU 1510. CPU 1506 can be coupled to GPU 1508 via a die-to-die (D2D) or chip-to-chip (C2C) interconnect 1512, such as a Ground-Referenced Signaling interconnect (GRS interconnect). CPU 1506 can be coupled to GPU 1510 via a D2D or C2C interconnect 1514. CPU 1506 can also couple to GPU 1508 and GPU 1510 via PCIe interconnects.

CPU 1506 can be coupled to one or more NICs or DPUs, which are coupled to one or more networks. For example, as illustrated in FIG. 15, CPU 1506 is coupled to a first NIC/DPU 1526, which is coupled to a network 1530. CPU 1506 is also coupled to a second NIC/DPU 1528, which is coupled to network 1530 via switch 1548. NIC/DPU 1526 and NIC/DPU 1528 can be coupled to network 1530 over Ethernet (ETH), NVLINK or InfiniBand (IB) connections, for example.

Computing system 1500 also includes a processing device 1504 with a multi-GPU architecture. In particular, processing device 1504 includes multiple subsystems including a CPU 1516, a GPU 1518, and a GPU 1520. CPU 1516 can be coupled to GPU 1518 via a D2D or C2C interconnect 1522. CPU 1516 can be coupled to GPU 1520 via a D2D or C2C interconnect 1524. CPU 1516 can also couple to GPU 1518 and GPU 1520 via PCIe interconnects. CPU 1516 can be coupled to one or more NICs or DPUs, which are coupled to one or more networks. For example, as illustrated in FIG. 15, CPU 1516 is coupled to a first NIC/DPU 1532, which is coupled to a network 1536. CPU 1516 is also coupled to a second NIC/DPU 1534, which is coupled to network 1536 via switch 1550. NIC/DPU 1532 and NIC/DPU 1534 can be coupled to network 1536 over Ethernet (ETH), NVLINK or InfiniBand (IB) connections.

In at least one embodiment, processing device 1502 and processing device 1504 can communicate with each other via a NIC/DPU 1538, such as over PCIe interconnects. Processing device 1502 and processing device 1504 can also communicate with each other over a high-bandwidth communication interconnects 1540, such as an NVLink interconnect or other high-speed interconnects. The packet switches in FIG. 15 may comprise, for example, Nvidia Quantum-2 switches. The NICs/DPUs in the figure may comprise, for example, Nvidia Bluefield DPUs.

In various embodiments, one or more of the interconnects 1512, 1514, 1522, 1524 may be optical interconnects disclosed herein. Additionally, in various embodiments, switches 1548, 1550 may be in communication with NIC/DPU 1528, 1532, respectively, via one or more optical interconnects disclosed herein. In some embodiments, NIC/DPU 1526, 1534 may be in communication with one or more additional elements via optical interconnects disclosed herein. For example, various elements of the computing system 1500 may be in communication with one another via one or more optical interconnects disclosed herein.

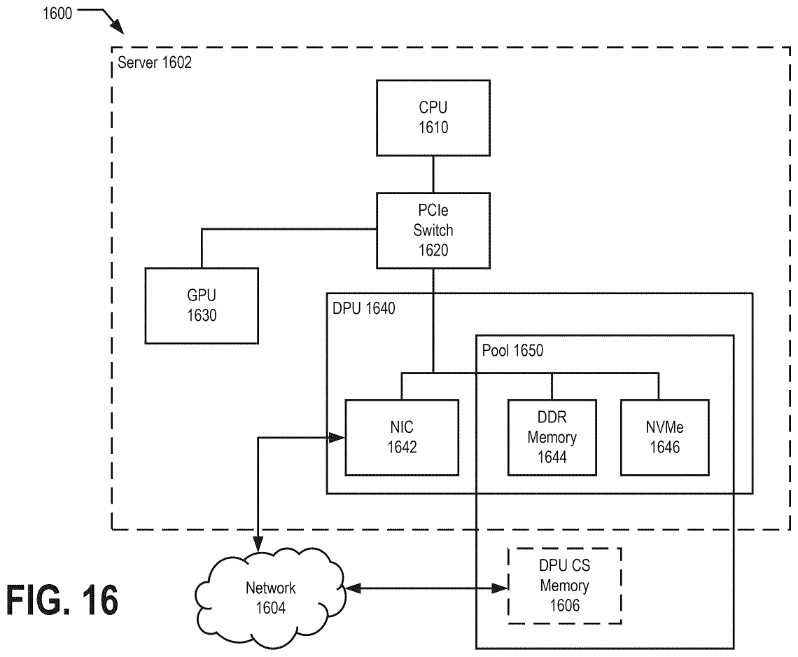

FIG. 16 illustrates an example computing environment 1600 in which forward pass offloading to available memory can be performed, in accordance with at least one embodiment. It should be appreciated that embodiments of the present disclosure may also be used with reference to alternative environments and that specific discussion of components may be provided by way of non-limiting example and may include equivalents. Moreover, various features have been removed for clarity and conciseness. Additionally, systems and methods may be used with a variety of different architectures. The example computing environment 1600 may include a server 1602 which may be used to perform high performance computing (HPC) workloads, such as AI training or machine learning model training. In an embodiment, the server 1602 may be an application instance or a compute node. The server 1602 may include a CPU 1610 associated with a switch 1620, such as a peripheral component interconnect express (PCIe) switch, which may control at least some data transmission over communication paths interconnecting various components. In an embodiment, the CPU 1610 may include a root complex processor.

The PCIe switch 1620 may also be associated with a GPU 1630 and a DPU 1640, and may transmit data between at least some of the CPU 1610, the GPU 1630, the DPU 1640, and other components (e.g., via one or more optical interconnects disclosed herein). In an embodiment, the PCIe switch 1620 may be associated with more than one GPU or more than one DPU. In another embodiment, the PCIe switch 1620 may be located within the DPU 1640. The PCIe switch 1620 may manage the transfer of at least some data between the CPU 1610, the GPU 1630, and the DPU 1640. In another embodiment, the number of GPUs associated with the PCIe switch 1620 may be equal to the number of DPUs associated with the PCIe switch 1620. In at least one embodiment, the server 1602 may include, without limitation, any number of the CPUs 1610, the PCIe switches 1620, the GPUs 1630, and/or the DPUs 1640, in any combination. For example, in at least one embodiment, server 1602 could include eight, sixteen, thirty-two, and/or more GPUs 1630. In at least one embodiment, communication paths interconnecting various components, including but not limited to the CPU 1610, the PCIe switch 1620, the GPU 1630, and the DPU 1640, in FIG. 16 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

The DPU 1640 may include a network interface controller (NIC) 1642, a DDR memory 1644, and a non-volatile memory express (NVMe) device 1646. The NIC 1642 may be able to interface with a network 1604, which may also interface with additional NVMe devices available to the DPU 1640, such as over fabric. In an embodiment, the DPU 1640 may not include the NVMe device 1646. In another embodiment, the NVMe device 1646 may be located on the server 1602 and not on the DPU 1640. In yet another embodiment, the computing environment 1600 may include more than one of the NVMe device 1646, such as a first NVMe device in the DPU 1640 and a second NVMe device on the server 1602 and associated directly with the PCIe switch 1620. In an embodiment, the DPU 1640 may not include the DDR memory 1644 and may include a computational storage services (CSS) in place of, or in addition to, the DDR memory 1644. For example, computing environment 1600 may include DPU computational storage (CS) memory 1606 available to the DPU 1640 as part of the CSS. The network 1604 may be able to interface with the DPU CS memory 1606 through the NIC 1642, according to any suitable interface protocol, such as remote direct memory access (RDMA) over Ethernet, InfiniBand, Fiber Channel, etc.

The total memory of the computing environment 1600 available for data storage may be expanded through the use of the DPU 1640 on nodes of the system. The DPU 1640 may have access to a pool 1650 of memory already available to the server 1602, such as double data rate (DDR) memory, on-board NVMe devices, NVMe devices over fabric, and CS. The pool 1650 of memory may include at least one of the DDR memory 1644, NVMe 1646, and the DPU CS memory 1606. The DPU 1640 may also be able to access the available memory of other DPUs as part of the pool 1650, and other DPUs may be able to access the available memory of DPU 1640, such as the pool 1650. This available memory can be accessed and utilized for data storage, without the addition of compute resources, such as compute nodes, which would be required using other solutions. The available pool 1650 accessible to the DPU 1640 may be provisioned for the server 1602 to expand the total memory available for data storage, such as to reduce the data storage load on the CPU 1610 or the GPU 1630, which can instead increase the utilization of their memory for processing. For example, during training of an AI, the model states, residual states, activation functions, and checkpoints can be stored, or offloaded, on the pool 1650 accessible to the DPU 1640.

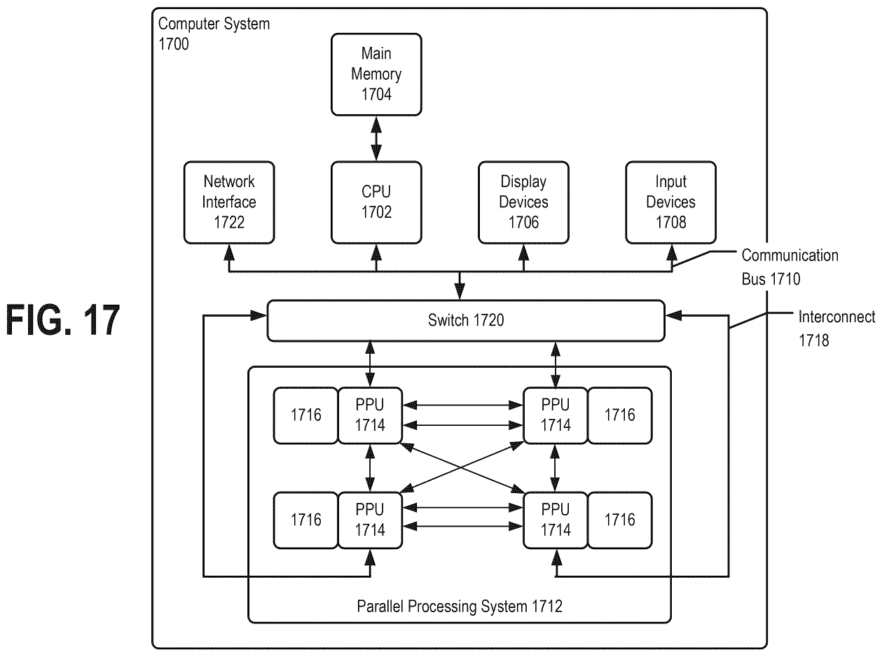

FIG. 17 illustrates a computer system 1700, according to at least one embodiment. In at least one embodiment, computer system 1700 comprises at least one optical interconnect of an example embodiment.

In at least one embodiment, computer system 1700 comprises, without limitation, at least one central processing unit (“CPU”) 1702 that is connected to a communication bus 1710 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 1700 includes, without limitation, a main memory 1704 and control logic (e.g., implemented as hardware, software, or a combination thereof) and data are stored in main memory 1704 which may take form of random access memory (“RAM”). In at least one embodiment, a network interface subsystem (“network interface”) 1722 provides an interface to other computing devices and networks for receiving data from and transmitting data to other systems from computer system 1700.

In at least one embodiment, computer system 1700, in at least one embodiment, includes, without limitation, input devices 1708, parallel processing system 1712, and display devices 1706 which can be implemented using a conventional cathode ray tube (“CRT”), liquid crystal display (“LCD”), light emitting diode (“LED”), plasma display, or other suitable display technologies. In at least one embodiment, user input is received from input devices 1708 such as keyboard, mouse, touchpad, microphone, and more. In at least one embodiment, each of foregoing modules can be situated on a single semiconductor platform to form a processing system.

In at least one embodiment, computer programs in form of machine-readable executable code or computer control logic algorithms are stored in main memory 1704 and/or secondary storage. Computer programs, if executed by one or more processors, enable system 1700 to perform various functions in accordance with at least one embodiment. memory 1704, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 1702; parallel processing system 1712; an integrated circuit capable of at least a portion of capabilities of both CPU 1702; parallel processing system 1712; a chipset (e.g., a group of integrated circuits designed to work and sold as a unit for performing related functions, etc.); and any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 1700 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a handheld electronic device, a mobile phone device, a television, workstation, game consoles, embedded system, and/or any other type of logic.

In at least one embodiment, parallel processing system 1712 includes, without limitation, a plurality of parallel processing units (“PPUs”) 1714 and associated memories 1716. In at least one embodiment, PPUs 1714 are connected to a host processor or other peripheral devices via an interconnect 1718 and a switch 1720 or multiplexer. In at least one embodiment, parallel processing system 1712 distributes computational tasks across PPUs 1714 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 1714, although such shared memory may incur performance penalties relative to use of local memory and registers resident to a PPU 1714. In at least one embodiment, operation of PPUs 1714 is synchronized through use of a command such as_syncthreads( ), wherein all threads in a block (e.g., executed across multiple PPUs 1714) to reach a certain point of execution of code before proceeding.

The PPUs 1714 may be in communication with one another and/or switch 1720 via one or more optical interconnects in accordance with example embodiments disclosed herein.

One type of optical modulation scheme is a ring-based optical modulation scheme. A ring-based optical link is an optical link that integrates a ring modulator. A ring modulator is an optical component that can be used to modulate a coherent optical carrier (e.g., coherent light) having a fixed wavelength. A ring modulator can include set of waveguides in which at least one waveguide is in the form of a closed loop (“ring waveguide”) disposed between one or more bus waveguides. The ring waveguide can support one or more resonant wavelengths (or frequencies) in which photons having constructive or destructive interference with the photons coming from the bus waveguide. Thus, when the optical carrier in the bus is at the vicinity of resonant wavelength, field enhancement occurs in the ring waveguide due to constructive (or destructive) interference, resulting in high optical intensity. Since only a portion of the wavelengths of the optical carrier will be at resonance within the ring waveguide, the ring waveguide can function as an optical filter. Ring waveguides exploit phenomena such as total internal reflection and optical coupling, which can depend on the index of refraction of the material of the ring waveguide (e.g., silicon). In some implementations, a ring modulator is a micro-ring modulator (MRM).

In some examples, processing circuitry (e.g., associated with a transmitter module 700, 910 or a receiver module 800, 915) can facilitate a method to tune ring modulators to wavelengths of coherent light using ring waveguide self-heating. For example, the processing circuitry can cause a heater to tune a ring waveguide of a ring modulator to a first resonance point and, upon tuning the ring waveguide to the first resonance point, disable the heater to cool the ring waveguide.

FIG. 18 illustrates an example system 1800 including a ring modulator 1805, according to at least one example embodiment. For example, the ring modulator 1805 can include a segmented ring resonator 100, 100′, as described above with reference to FIGS. 1A and 1B. For example, the ring modulator 1805 can include a pair of bus waveguides 1810 and 1820. For example, the bus waveguide 1810 can be a through bus waveguide and the bus waveguide 1820 can be a drop bus waveguide. In some embodiments, and as shown in this illustrative example, the bus waveguides 1810 and 1820 are linear (e.g., horizontal) waveguides. However, the bus waveguides 1810 and 1820 can have any suitable shape in accordance with embodiments described herein.

The bus waveguides 1810 and 1820 can have respective ports, which can be used to address and probe the behavior of the ring modulator 1805. As shown in this illustrative example, the bus waveguide 1810 can have ports 1812-1 and 1812-2, and the bus waveguide 1820 can have ports 1822-1 and 1822-2. For example, port 1812-1 can be referred to as an input port, port 1812-2 can be referred to as a through port, port 1822-1 can be referred to as a drop port and port 1822-2 can be referred to as an add port. Accordingly, in this illustrative example, the ring modulator 1805 can be a four-port ring modulator.

The ring modulator 1805 further includes a ring waveguide 1830 (e.g., similar to segmented ring resonator 100, 100′) disposed between the bus waveguides 1810 and 1820. The ring waveguide 1830 defines a closed optical loop. The arrow “r” denotes the effective ring radius of the ring waveguide 1830. The effective ring radius of the ring waveguide 1830 can be on the order of micrometers or microns (μm) in some embodiments. In some embodiments, the effective ring radius of the ring waveguide 1830 is between about 1 μm to about 10 μm.

The ring modulator 1805 is configured to receive at least one wavelength of radiation generated by a wavelength generator (e.g., optical source 705). In some embodiments, the at least one wavelength of radiation includes multiple wavelengths of radiation. For example, a tunable optical wave (e.g., laser light) having a number of wavelengths of radiation can be received in the port 1812-1. The ring waveguide 1830 can be tuned to a resonant wavelength (λ₀) such that photons having the resonant wavelength are coupled to the ring waveguide 1830 and re-routed to the port 1822-1, while photons not having the resonant wavelength pass through toward the port 1812-2. Accordingly, the ring waveguide 1830 can function as a spectral filter.

Illustratively, assume that a first photon having the resonant wavelength is received by the port 1812-1. As this photon travels left to right, the first photon enters the ring waveguide 1830 via optical coupling. If a second photon having the resonant wavelength is received by the port 1812-1, the subsequent photon adds coherently (in phase and polarization and frequency) with the first photon that is already in the ring waveguide 1830. This initiates a process referred to as field enhancement, in which photons having the resonant wavelength continue to build up within the ring waveguide 1830. Arrow “k₁” denotes a first coupling coefficient corresponding to an amount of optical power coupled to the ring waveguide 1830 from the bus waveguide 1810 (e.g., percentage).

The waveguides 1810, 1820, 1830 can be formed from any suitable material that has properties (e.g., index of refraction) to enable the optical coupling of light having the resonant wavelength within the ring waveguide 1830. In some embodiments, the waveguides 1810, 1820, 1830 are formed from a semiconductor material. For example, the waveguides 1810, 1820, 1830 can be formed from silicon (Si), SiN, LiNbO₃, or BaTiO₃. Alternatively, at least one of the waveguides 1810, 1820, 1830 can be formed from a different material.

The field enhancement process described above cannot occur indefinitely. At a certain electrical field or optical power level, the number of photons having the resonant wavelength within the ring waveguide 1830 can reach a saturation threshold and begin to radiate or couple out of the ring waveguide 1830. Arrow “k₂” denotes a second coupling coefficient corresponding to an amount of optical power coupled from the ring waveguide 1830 to the bus waveguide 1820 (e.g., percentage).

The optical power level can be correlated with a quality factor of the ring modulator 1805, Q. The quality factor Q is a dimensionless quantity that serves as a metric of “sharpness” of resonance or filtering achieved by the ring waveguide 1830. The quality factor Q can be used to determine the average number of round-trip turns or cycles that a photon can make before leaving the ring waveguide 1830 and entering the bus waveguide 1820. For example, the quality factor Q can be directly (e.g., linearly) related to average photon lifetime, which is the average time that a photo will spend in the ring waveguide 1830 before exiting. Accordingly, the higher the quality factor Q, the greater the average photon lifetime and number of round-trip turns. The quality factor Q can be inversely proportional to a full width at half maximum (FWHM) value of the transmission spectra observed to exit through the port 1812-2. For example, Q=λ₀/FWHM. Here, the FWHM is the difference or distance between two wavelength values, observed at the port 1812-2, having an optical power level determined to be equal to half of a maximum optical power value. For example, the optical power level can be modeled as a transfer function (e.g., Lorentzian). Accordingly, a greater FWHM value translates into a lower Q value.

At least one electrical component can be operatively coupled (e.g., integrated into) the ring waveguide 1830 as a heater to tune the ring waveguide 1830. For example, applying a voltage (e.g., bias) to the at least one electrical component can cause a modification to at least the index of refraction of the ring waveguide 1830, which can tune the quality factor Q and thus tune the ring waveguide 1830. The at least one electrical component can include any suitable electronic component(s) in accordance with embodiments described herein. In some embodiments, the at least one electrical component can include at least one of a diode, a resistor, or a transistor (e.g., field-effect transistor (FET)).

As shown, the at least one electrical component can include a diode 1840. In some embodiments, the diode 1840 is a P-N diode including a P-N junction between P-type semiconductor material and N-type semiconductor material. In some embodiments, the diode 1840 is a P-I-N diode, in which intrinsic semiconductor material (I) is disposed between P-type and N-type semiconductor material. In some embodiments, the diode 1840 can function as a delay adder. For example, when the diode 1840 is in an off state (i.e., turned off), the ring modulator 1805 can have an initial quality factor Q (Q₀), an initial FWHM (FWHM₀) and an initial average photon lifetime τ (τ₀). When processing circuitry causes an amount of positive voltage to be applied to the diode 1840, the diode 1840 can generate a corresponding number of charge carriers for injection into the ring waveguide 1830. These charge carriers can modify the index of refraction of the ring waveguide 1830 in a manner that increases the FWHM from the FHWM₀ to a new FHWM (FHWM₁). For example, a relationship can exist between charge carrier density and the index of refraction. The effect can be diminished as the positive voltage exceeds the threshold voltage for the diode. Since FHWM is inversely proportional to the quality factor Q, the FHWM₁ corresponds to a new quality factor Q (Q₁) that is less than Q₀. The decrease in the quality factor from Q₀ to Q₁ corresponds to a decrease in the average photon lifetime τ from τ₀ to a new average photon lifetime τ (τ₁). In this manner, the diode 1840 behaves as a delay modification tool. Additionally or alternatively, in some embodiments, the diode 1840 can function as a delay remover. For example, if the diode 1840 is a P-N diode, then an amount of negative voltage applied to the diode 1840 can expand the depletion region between the P-type semiconductor material and the N-type semiconductor material. This can cause removal of charge carriers from ring waveguide 1830.

Additionally or alternatively, the at least one electrical component can include a resistor (e.g., resistive heater) 1850. For example, when processing circuitry causes an amount of voltage to be applied to the resistor 1850, the resistor 1850 can tune the local temperature which tunes the on-resonance wavelength for the ring waveguide 1830.

The diode 1840 and the resistor 1850 can tune the ring waveguide 1830 with different amounts of granularity. For example, the diode 1840 can be a fine-delay component and the resistor 1850 can be a coarse-delay component. Moreover, multiple diodes, resistors, transistors, etc. that have respective sensitivities can be coupled to the ring waveguide 1830. Accordingly, the at least one electrical component can include multiple electrical components to more accurately tune the at least one ring modulator in some embodiments.

The optical ring resonator can be operated as both a demultiplexer and a modulator. Electronics can encode data onto an optical channel. Such a method of operating the device results in an encoded optical channel being output on the output waveguide.

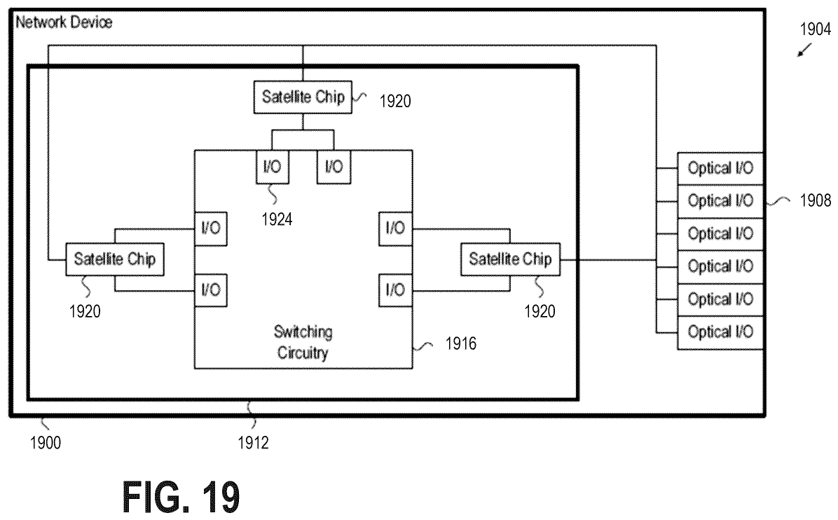

Co-packaging may refer to the close integration of different electrical and/or optoelectronic chips in the same package. FIG. 19 is a block diagram that schematically illustrates a co-packaged Networking Device 1900, in accordance with an embodiment that is disclosed herein. The different chips that constitute a co-packaged Networking Device are assembled on a single substrate in what is typically called the MCM assembly 1912. The MCM assembly 1912 can include a switching circuitry 1916 surrounded by peripheral or satellite chips 1920. In some embodiments, the switching circuitry 1916 and surrounding satellite chips 1920 are all mounted on a common substrate, although such a configuration is not required. The MCM assembly 1912 may be provided in a larger housing of the networking device 1900, positioned behind the front panel 1904. The switching circuitry 1916 may include one or more core digital Application Specific Integrated Circuits (ASICs), CPUs, GPUs, microprocessors, FPGAs, combinations thereof, and the like. The switching circuitry 1916 may include a number of input ports and/or output ports 1928. The Input/Output (I/O) ports 1924 may include electrical ports and/or optical ports. Additionally, the switching circuitry 1916 may include a combination of electrical blocks and optical blocks. The electrical blocks of the switching circuitry 1916 may include a number of electrical switches that are configured to route signals in an electrical domain. The optical blocks of the switching circuitry 1916 may include a number of optical components that are configured to generate, detect, and route signals in an optical domain. The MCM assembly 1912, in some embodiments, may concern or include multiple satellite chips 1920 that are assembled on the same substrate as the switching circuitry 1916. In some embodiments, a configuration of the optical block(s) and a configuration of the electrical block(s) depends (e.g., is based on) on the number of optical ports in the I/O ports 1924.

As discussed above, optical I/Os 1908, which may also be referred to as optical connectors, are placed at the front panel 1904. As mentioned above, connectivity between the MCM assembly 1912 and optical I/Os 1908 may be transferred to the front panel 1904 through optical fibers. This connection may be made directly with an optical I/O 1924 of the switching circuitry or may be made with one or more of the satellite chips 1920. The connection is often made with one or more of the satellite chips 1920 because the satellite chips 1920 may include the electro-optic converters and, possibly, the serializer/deserializer (SERDES) to natively support the connection. The satellite chips 1920 may include one or more of aDSP processor, driver, trans-impedance amplifier, laser, modulator, photodiode, serializer-deserializer, or the like.

Some embodiments of the present disclosure are directed to a multi-chip module (MCM) with a centrally positioned main die and a plurality of peripherally positioned MCM sockets configured to mechanically receive and electrically connect mezzanine packages, which may include co-packaged optics (CPO) packages and co-packaged copper (CPC) packages. Each mezzanine package may include a package substrate including a connector portion that is configured to engage the MCM socket and a main portion extending beyond the periphery of the MCM substrate. The main portion of the mezzanine package may be configured to receive optical devices and/or integrated circuits, such as via mezzanine sockets, to allow connections to be made between the optical devices and/or integrated circuits/RF copper cable connectors and the main die of the MCM. Due to the extension of the mezzanine package beyond the periphery of the MCM substrate, the physical size of the MCM substrate may remain small to reduce cost and avoid the previously discussed production challenges, while allowing connections to a number of optical devices and integrated circuits via the mezzanine packages, which occupy the relatively inexpensive space around the periphery of the MCM substrate. As used herein, the terms “co-packaged optic” (or “CPO”) and “co-packaged copper” (or “CPC”) may refer to an advanced heterogeneous integration of either optics and silicon or copper and silicon, in which either integration may be implemented on a single packaged substrate. The CPO may utilize pluggable optical modules that include an optical engine (OE) to convert optical signals to electrical signals and electrical signals to optical signals. The CPO may further be comprised of an optical component on a photonics die and an electrical component on an electrical die.

As used herein, a ball grid array (BGA) may be a type of surface-mount packaging used for integrated circuits. BGA packages use an array of metallic conductor balls arranged in a grid to permanently mount devices such as microprocessors on a PCB. The metallic conductor balls may then undergo the reflow process described above, wherein the metallic conductor balls may be preheated, then melted to bond the IC to a substrate to form an IC package.

As used herein, the term “flip chip (FC)” may refer to a method for interconnecting dies, such as semiconductor devices, IC chips, integrated passive devices, and microelectromechanical systems (MEMS), to external circuitry with solder bumps that have been deposited onto chip pads. The solder bumps may be deposited onto chip pads on the top side of the wafer during final wafer processing. The chip may be mounted to external circuitry (such as a circuit board or another chip or wafer) by “flipping” the chip, such that the chip's top side faces down and is positioned to allow the pads of the chip to align with matching pads on the external circuit. Solder is reflowed to complete the interconnect.

### Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A segmented ring resonator comprising:
a plurality of ring waveguide segments; and
a plurality of reflectors, wherein each reflector of the plurality of reflectors is configured to optically couple a pair of ring waveguide segments of the plurality of ring waveguide segments to define a closed optical path through the plurality of ring waveguide segments.

2. The segmented ring resonator or claim 1, wherein the plurality of ring waveguide segments comprise a first waveguide formed as a first arc and a second waveguide formed as a second arc, and the plurality of reflectors comprises a pair of reflectors, wherein the pair of reflectors are configured to optically couple respective ends of the first waveguide and the second waveguide.

3. The segmented ring resonator of claim 2, wherein the first arc and the second arc are characterized by a radius of curvature and an optical path of the segmented ring resonator has an optical length that is less than half a circumference of a circle characterized by the radius of curvature.

4. The segmented ring resonator of claim 3, wherein the first waveguide and the second waveguide comprise a waveguide material and a refractive index of the waveguide material is substantially stable over an operation range of temperatures.

5. The segmented ring resonator of claim 2, wherein the first arc and the second arc are characterized by a non-zero radius of curvature that is larger than an effective ring radius of the segmented ring resonator.

6. The segmented ring resonator of claim 1, wherein at least one reflector of the plurality of reflectors is a Bragg reflector.

7. The segmented ring resonator of claim 6, wherein the Bragg reflector is configured to satisfy one or more phase matching conditions.

8. The segmented ring resonator of claim 6, wherein the Bragg reflector is configured as confocal ellipses.

9. The segmented ring resonator of claim 6, wherein a reflectivity of the Bragg reflector increases adiabatically with a distance into the Bragg reflector from a front surface of the Bragg reflector.

10. The segmented ring resonator of claim 1, wherein each of the plurality of reflectors is a Bragg reflector.

11. The segmented ring resonator of claim 1, wherein the plurality of ring waveguide segments comprise a waveguide material.

12. The segmented ring resonator of claim 11, wherein the waveguide material is SiN, LiNbO₃, or BaTiO₃.

13. An optical element comprising:
a segmented ring resonator comprising:
a plurality of ring waveguide segments, and
a plurality of reflectors, wherein each reflector of the plurality of reflectors is configured to optically couple a pair of ring waveguide segments of the plurality of ring waveguide segments to define a closed optical path through the plurality of ring waveguide segments; and
a through waveguide that is evanescently coupled to the segmented ring resonator, wherein the optical element is one of a modulator or an optical filter.

14. The optical element of claim 13, wherein the plurality of ring waveguide segments are each characterized by a radius of curvature and an optical path of the segmented ring resonator has an optical length that is less than half a circumference of a circle characterized by the radius of curvature.

15. The optical element of claim 13, wherein the plurality of ring waveguide segments comprise a waveguide material and a refractive index of the waveguide material is substantially stable over an operation range of temperatures.

16. An optical transceiver comprising:
one or more optical elements, each optical element comprising a segmented ring resonator, wherein the segmented ring resonator comprises:
a plurality of ring waveguide segments, and
a plurality of reflectors, wherein each reflector of the plurality of reflectors is configured to optically couple a pair of ring waveguide segments of the plurality of ring waveguide segments to define a closed optical path through the plurality of ring waveguide segments; and
a through waveguide that is evanescently coupled to the segmented ring resonator of at least one optical element of the one or more optical elements, wherein the optical element is a respective one of a modulator or an optical filter.

17. The optical transceiver of claim 16, wherein the plurality of ring waveguide segments are each characterized by a radius of curvature and an optical path of the segmented ring resonator has an optical length that is less than half a circumference of a circle characterized by the radius of curvature.

18. The optical transceiver of claim 17, wherein the one or more optical elements comprise a plurality of optical elements, the segmented ring resonator of each of the plurality of optical elements is evanescently coupled to the through waveguide, the segmented ring resonator of each of the plurality of optical elements defines a respective optical path having a respective optical path length, and the plurality of optical elements comprise respective segmented ring resonators that define different respective optical path lengths.

19. The optical transceiver of claim 16, wherein the one or more or more optical elements are respective modulators each configured to encode a stream of data onto an optical signal characterized by a respective wavelength.

20. The optical transceiver of claim 16, wherein the one or more optical elements are respective optical filters each configured to filter an optical channel characterized by a respective wavelength from a multi-wavelength optical signal.
